(19) United States
(12) Patent Application Publication
(10) Pub. No.: US 2021/0114477 A1
(43) Pub. Date: Apr. 22, 2021

(54) SYSTEM AND METHOD FOR INTEGRATING A VEHICLE AND A DOCKING STRUCTURE, AND A VEHICLE THEREFOR

(71) Applicant: Mazda Motor of America, Inc., Irvine, CA (US)

(72) Inventors: Julien Ernest Andre MONTOUSSE, Dana Point, CA (US); Gregory Pierre WARMSLEY, Costa Mesa, CA (US); Ian Everett HEDGE, Santa Ana, CA (US); Napoleon Junior MATHEUS, Laguna Niguel, CA (US); Adam Thomas WOODWARD, Irvine, CA (US); Reginald Gamboa ACOSTA, Dana Point, CA (US); ByungJoon LEE, Irvine, CA (US)

(73) Assignee: Mazda Motor of America, Inc., Irvine, CA (US)

(21) Appl. No.: 17/077,822

(22) Filed: Oct. 22, 2020

Related U.S. Application Data
(60) Provisional application No. 62/924,385, filed on Oct. 22, 2019.

(51) Int. Cl. B60L 53/36; B60L 53/16

(52) U.S. Cl. CPC B60L 53/36; B60N 5/00; B60L 53/16

(57) ABSTRACT

An integration between vehicle and a docking structure includes reconfiguring the vehicle for docking with the docking structure. The integration includes autonomous or automatic docking without human control; and transfer of power and data to and from the vehicle and the docking structure. A support height of a transition support of the vehicle is set to approximately the support height of a platform of the docking structure.

### CROSS-REFERENCE TO RELATED APPLICATIONS

This application claims the benefit of priority to U.S. Provisional Patent Application No. 62/924,385, filed on Oct. 22, 2019, which is hereby incorporated by reference in its entirety.

### TECHNICAL FIELD

This disclosure relates to systems, apparatus, and methods for integrating an interior of a vehicle with an interior of an occupancy space such as an office, home, or other interior of a structure that is configured to be occupied by a human occupant or operator of a vehicle. Such integration can also be with a docking structure that may be at least partially external to an occupancy structure. Occupancy could include long term occupancy, such as many hours to days and longer, such as might occur in a residence, or short term occupancy or a brief visit.

### BACKGROUND

Vehicles such as cars, trucks, vans, sport-utility vehicles and the like are conventionally parked at an exterior of a building, or are parked in a space, such as a garage, that is physically separated from an interior space that is configured for occupancy, such as an office, home, or the like.

### SUMMARY

This disclosure provides a vehicle comprising a longitudinally extending vehicle body, a vehicle seat, and a transition support. The longitudinally extending vehicle body forms a vehicle interior, a vehicle exterior, and a vehicle opening at a location between the vehicle interior and the vehicle exterior. The vehicle body includes a vehicle door movable between an open position providing access between the vehicle interior and the vehicle exterior through the vehicle opening and a closed position limiting access between the vehicle interior and the vehicle exterior. The vehicle seat is positioned in the vehicle interior and the vehicle seat has a horizontally extending seating surface positioned at a seating height to provide vertical support to a user. The transition support is positioned adjacent to the vehicle seat and includes a horizontally extending upper surface positioned at the vehicle opening at a support height at or greater than the seating height when the vehicle door is in both the closed position and the open position to vertically support a user during movement of a user between the vehicle interior and the vehicle exterior through the vehicle opening.

This disclosure also provides a method of integrating a vehicle with a docking structure. The method includes providing the vehicle with a longitudinally extending vehicle body forming a vehicle interior, a vehicle exterior, and a vehicle opening at a location between the vehicle interior and the vehicle exterior. The vehicle includes a vehicle seat positioned in the vehicle interior and a transition support including a horizontally extending upper surface positioned adjacent the vehicle seat to provide vertical support to a user. The method further includes moving the vehicle in a moving direction alongside the docking structure, and stopping movement of the transition support in the moving direction relative to a docking structure platform when the transition support is aligned in an aligned position with the docking structure platform along the moving direction of the vehicle. The method further yet includes further moving the vehicle in the moving direction relative to the docking structure platform and the transition support after the transition support is aligned with the docking structure platform.

This disclosure also provides a vehicle and docking structure integration system, comprising a longitudinally extending vehicle body, a vehicle seat, a transition support, and a docking structure. The longitudinally extending vehicle body forms a vehicle interior, a vehicle exterior, and a vehicle opening at a location between the vehicle interior and the vehicle exterior. The vehicle body includes a vehicle door movable between an open position providing access between the vehicle interior and the vehicle exterior through the vehicle opening and a closed position limiting access between the vehicle interior and the vehicle exterior. The vehicle seat is positioned in the vehicle interior. The vehicle seat has a horizontally extending seating surface positioned at a seating height to provide vertical support to a user. The transition support is positioned adjacent the vehicle seat and includes a horizontally extending upper surface positioned at the vehicle opening at a support height greater than the seating height when the vehicle door is in both the closed position and the open position to vertically support a user during movement of a user between the vehicle interior and the vehicle exterior through the vehicle opening. The docking structure includes a docking structure platform positioned at the support height in vertical and horizontal alignment with the transition support.

This disclosure also provides a vehicle and docking structure system, comprising a longitudinally extending vehicle body, a vehicle seat, a transition support, and a docking structure. The longitudinally extending vehicle body forms a vehicle interior, a vehicle exterior, and a vehicle opening at a location between the vehicle interior and the vehicle exterior. The vehicle body includes a vehicle door movable between an open position providing access between the vehicle interior and the vehicle exterior through the vehicle opening, and a closed position limiting access between the vehicle interior and the vehicle exterior. The vehicle seat is positioned in the vehicle interior and the vehicle seat has a horizontally extending seating surface positioned at a seating height to provide vertical support to a user. The transition support is positioned adjacent the vehicle seat and includes a horizontally extending upper surface positioned at the vehicle opening at a support height greater than the seating height when the vehicle door is in both the closed position and the open position to vertically support a user during movement of a user between the vehicle interior and the vehicle exterior through the vehicle opening. The docking structure includes a docking structure platform positioned at the support height in vertical and horizontal alignment with the transition support.

Advantages and features of the embodiments of this disclosure will become more apparent from the following detailed description of exemplary embodiments when viewed in conjunction with the accompanying drawings.

### BRIEF DESCRIPTION OF THE DRAWINGS

FIG. 1 shows a system level diagram of an exemplary occupancy space vehicle integration system in accordance with an exemplary embodiment of the present disclosure.

FIG. 2 shows a block diagram of an embodiment of the occupancy space vehicle integration system of FIG. 1 in accordance with an exemplary embodiment of the present disclosure.

FIGS. 3 and 4 show a first process flow of the occupancy space vehicle integration system of FIG. 1 in accordance with an exemplary embodiment of the present disclosure.

FIGS. 5 and 6 show a second process flow of the occupancy space vehicle integration system of FIG. 1 in accordance with another exemplary embodiment of the present disclosure.

FIGS. 7-10 show a third process flow of the occupancy space vehicle integration system of FIG. 1 in accordance with a further exemplary embodiment of the present disclosure.

FIG. 11 shows a perspective view of a vehicle in accordance with an exemplary embodiment of the present disclosure.

FIG. 12 shows a plan view of an occupancy space, the plan view including an exterior adjacent to the occupancy space with the vehicle of FIG. 11 shown approaching the exterior of the occupancy space in accordance with an exemplary embodiment of the present disclosure.

FIG. 13 shows another plan view of the exterior space adjacent to the occupancy space of FIG. 12, with the vehicle positioned in a driveway of the exterior space in accordance with an exemplary embodiment of the present disclosure.

FIG. 14 shows a view of the exterior the occupancy space of FIG. 12 as seen from the interior of the vehicle of FIG. 11.

FIG. 15 shows a view of an entryway into the occupancy space of FIG. 12 in accordance with an exemplary embodiment of the present disclosure.

FIG. 16 shows a perspective view of the interior of the occupancy space of FIG. 12 looking toward the entryway in accordance with an exemplary embodiment of the present disclosure.

FIG. 17 shows a view of the vehicle that has approached and is entering the occupancy space of FIG. 12 in accordance with an exemplary embodiment of the present disclosure.

FIG. 18 shows a further view of the vehicle and the occupancy space of FIG. 17 as the vehicle continues to enter the occupancy space in accordance with an exemplary embodiment of the present disclosure.

FIG. 19 shows a view of the vehicle and the occupancy space of FIG. 17, with the vehicle moving to align a transition support with a docking platform location with respect to features of the occupancy space in accordance with an exemplary embodiment of the present disclosure.

FIG. 20 shows a view of the vehicle and the occupancy space of FIG. 17, with the vehicle positioned at a parked position or location and anchored with respect to features of the occupancy space in accordance with an exemplary embodiment of the present disclosure.

FIG. 21 shows a view of the vehicle of FIG. 11 configured in a driving mode of operation in accordance with an exemplary embodiment of the present disclosure with a driver's side door removed to show interior features of the vehicle.

FIG. 22 shows a driver' s side view of the vehicle of FIG. 11 with a driver's door removed and with the vehicle in an approach mode in accordance with an exemplary embodiment of the present disclosure.

FIG. 23 shows a perspective view of the vehicle and the occupancy space of FIG. 19 with the vehicle aligned to the occupancy space in accordance with an exemplary embodiment of the present disclosure.

FIG. 24 shows a driver's side view of the vehicle similar to the view of FIG. 17, with the vehicle aligned to the occupancy space in accordance with an exemplary embodiment of the present disclosure.

FIG. 25 shows a further driver's side view of the vehicle similar to the view of FIG. 24 as the vehicle prepares to transition from an aligned position with respect to the occupancy space to the parked position or location in the occupancy space in accordance with an exemplary embodiment of the present disclosure.

FIG. 26 shows a perspective view of the vehicle of FIG. 24, with the vehicle parked and anchored to the occupancy space in accordance with an exemplary embodiment of the present disclosure.

FIG. 27 shows a further view of the vehicle of FIG. 26 with the driver's side door open.

FIG. 28 shows a driver's side view similar to the view of FIG. 27, with the vehicle anchored at the parked position with respect to the occupancy space and a driver positioned to exit the vehicle in accordance with an exemplary embodiment of the present disclosure.

FIG. 29 shows a plan view of the parked vehicle of FIG. 27 positioned in relationship to docking structures in the occupancy space in accordance with an exemplary embodiment of the present disclosure.

FIG. 30 shows a plan view of a portion of the occupancy space and vehicle of FIG. 29 with the vehicle approaching the parked position with respect to the occupancy space in accordance with an exemplary embodiment of the present disclosure.

FIG. 31 shows a plan view similar to FIG. 30, with the vehicle at the parked position prior to engagement of the anchor and an electrical connection in accordance with an exemplary embodiment of the present disclosure.

FIG. 32 shows a plan view similar to FIG. 31, with an anchor and an electrical connector extended to interface and integrate the vehicle with the docking structure in accordance with an exemplary embodiment of the present disclosure.

FIG. 33 shows a plan view of an anchor having an integral electrical connector in accordance with an exemplary embodiment of the present disclosure, with the anchor securing and integrating the vehicle with a docking structure.

FIG. 34 shows a perspective view of the parked vehicle of FIG. 27 prior to engagement of the anchor between the vehicle and the docking structure and prior to electrical connection between the vehicle and the docking structure.

FIG. 35 shows a cross-sectional view of the vehicle of FIG. 27 along the lines 35-35, showing a seat and supporting seat rail configuration in accordance with an exemplary embodiment of the present disclosure.

FIG. 36 shows a stylized view of a user, which may be a driver or passenger, sitting in a vehicle seat of the parked and anchored vehicle of FIG. 27.

FIG. 37 shows a stylized view of the user of FIG. 36 sliding onto a vehicle transition support from the vehicle seat of the parked and anchored vehicle of FIG. 27.

FIG. 38 shows a stylized view of the user of FIG. 37 sliding from the transition support onto a structure platform of the docking structure.

FIG. 39 shows a cross section through the anchor, which can include a structure anchor and a vehicle anchor, with the driver's side vehicle door open in accordance with an exemplary embodiment of the present disclosure.

FIG. 40 shows a cross section through the structure anchor and the vehicle anchor of the vehicle of FIG. 39 with the driver's side vehicle door closed and the structure anchor retracted in accordance with an exemplary embodiment of the present disclosure.

FIG. 41 shows an enlarged plan view of an anchor and electrical connector in accordance with an exemplary embodiment of the present disclosure.

FIG. 42 shows an enlarged view of a portion of a sliding door and alignment sensor for the configuration of FIG. 41 for a vehicle in accordance with an exemplary embodiment of the present disclosure.

FIG. 43 shows an elevation view of the sliding door and alignment sensor of FIG. 42 when the vehicle is in a seat alignment position where the vehicle seat is aligned to the docking structure in accordance with an exemplary embodiment of the present disclosure.

FIG. 44 shows an elevation view of the sliding door and alignment sensor of FIG. 42 when the vehicle is transitioning from the seat alignment position to the transition support alignment position in accordance with an exemplary embodiment of the present disclosure.

FIG. 45 shows an elevation view of the sliding door and alignment sensor when the vehicle is further transitioned from the position shown in FIG. 44 to the transition support alignment position, which can be the parked position in accordance with an exemplary embodiment of the present disclosure.

FIG. 46 shows an elevation view of the sliding door and alignment sensor when the vehicle is at the transition support alignment position, which is also the parked position in the embodiment of FIG. 46, and which becomes the anchored position when the vehicle is anchored to the occupancy space and/or the docking structure, in accordance with an exemplary embodiment of the present disclosure.

FIG. 47 shows an enlarged plan view of an anchor and integral electrical connector in accordance with another exemplary embodiment of the present disclosure.

FIG. 48 shows an enlarged view of a portion of a sliding door and alignment sensor for the configuration of FIG. 47 in accordance with an exemplary embodiment of the present disclosure.

FIG. 49 shows an elevation view of the sliding door and alignment sensor of FIG. 48 when the vehicle is in the seat alignment position where the vehicle seat is aligned to the docking structure in accordance with an exemplary embodiment of the present disclosure.

FIG. 50 shows an elevation view of the sliding door and alignment sensor of FIG. 48 when the vehicle is transitioning from the seat alignment position to the transition support alignment position in accordance with an exemplary embodiment of the present disclosure.

FIG. 51 shows an elevation view of the sliding door and alignment sensor when the vehicle is further transitioned from the position shown in FIG. 50 to the transition support alignment and parked position in accordance with an exemplary embodiment of the present disclosure.

FIG. 52 shows an elevation view of the sliding door and alignment sensor of FIG. 48 when the vehicle is at the transition support alignment and parked position, which become the anchored position when the vehicle is anchored to the occupancy space and/or the docking structure, in accordance with an exemplary embodiment of the present disclosure.

FIG. 53 shows a perspective view of the vehicle of FIG. 27 when viewed from a front right side of the vehicle.

FIG. 54 shows a plan view of another vehicle anchored in the occupancy space in accordance with an exemplary embodiment of the present disclosure.

FIG. 55 shows a side view of the vehicle of FIG. 54 with the left side doors open.

FIG. 56 shows a plan view of a vehicle with a portion of the vehicle cut away in accordance with an exemplary embodiment of the present disclosure.

FIG. 57 shows an enlarged plan view of the vehicle of FIG. 70.

### DETAILED DESCRIPTION

Modern human occupied spaces have evolved with the evolution of technology. Indeed, homes, offices, and other occupied spaces are configured to include, for example, wires, wireless technology, or a combination of the two to provide internet communications and television, including command and control technology for what is often described as smart technology. However, the evolution of such occupied spaces has generally left a physically separate space occupied by a vehicle as an under-utilized cavern of tools, boxes, and spider webs.

The present disclosure describes an integration process that operates to align a transition support of a vehicle, such as vehicle 14 described herein, with an occupancy space or interior of a structure, such as occupancy space 12 described herein, such that an upper, horizontally extending surface of the vehicle transition support, such as vehicle transition support 236, is aligned horizontally and vertically with an upper, horizontally extending surface of a docking structure platform, such as platform 214, at a support height in the occupancy space as part of integrating the vehicle with the occupancy space. The alignment of the transition support with the docking structure platform enables smooth and easy movement of the user from the vehicle seat to the docking structure platform while transforming the vehicle into an integral structural component of the occupancy space.

The occupancy space, such as a living room, can be located within a structure, such as a dwelling, of the present disclosure. The docking structure platform, such as a bench for seating, can be part of a docking structure, such as a docking structure 74 described herein, which can be positioned in the occupancy space of the structure. In an alternative embodiment, the docking structure can be positioned alongside an exterior of a structure, such as a home, office, or other building. In addition to the upper horizontally extending surface, the docking structure platform includes a side surface that faces in a direction of the vehicle to oppose an exterior of the vehicle when the vehicle is alongside the docking structure.

The vehicle also includes a seat having a horizontally extending seating surface positioned at a seating height to provide vertical support to a user, who can be a driver or a passenger. The transition support includes a horizontally extending upper surface positioned adjacent to the vehicle seat and extending to a vehicle opening formed by a vehicle door at a support height that is at or greater than the seating height when the vehicle door is in both the closed position and the open position.

The transition support can include a movable portion, and the movable portion can be aligned with the docking structure or a docking platform of the docking structure. In a preferred embodiment, the transition support can be aligned vertically and horizontally to the horizontally extending upper surface of the docking structure. In another preferred embodiment, the transition support can be aligned to the front face of the docking structure. In a further preferred embodiment, the vehicle seat is also aligned with the docking structure exterior to the vehicle, which can be the same location on the docking structure where the transition support is aligned. The vehicle can be moved relative to the movable portion of the transition support while maintaining the alignment of the movable portion of the transition support from a first position to a second position. In yet another preferred embodiment, the transition support includes a front face and the front face is aligned to a front face of the docking structure when the vehicle is at the aligned position with respect to the docking structure. Of course, when the front face of the transition support and the front face of the docking structure are aligned, the upper surface of the transition support and the upper surface of the docking structure are aligned in approximately a same plane. It should also be noted that there may be some degree of tilt of the upper surface of the docking platform of the docking structure with respect to the upper surface of the transition support. In an exemplary embodiment, the angle of the upper surface of the transition support can be adjusted by one or more vehicle systems, such as pneumatic adjusters. In another exemplary embodiment, the tilt of the upper surface of the docking structure platform can be adjusted to match the tilt of the upper surface of the transition support.

As the vehicle moves alongside the docking structure platform, the vehicle interior can be opened or expanded by moving a vehicle seat rearwardly, by retracting a steering wheel into a vehicle dash, and by pivoting and lowering a vehicle headrest. The movement of the seat, steering wheel, and headrest is preferably overlapping and even more preferably at the same time, simultaneously, or in parallel. The vehicle may also include an access door or access panel that opens to enable access to a vehicle connector and a vehicle anchor, and the access door or panel can preferably move at the same time as the movement of the seat, the steering wheel, and the headrest. The vehicle moves to a park position where the vehicle is anchored to the occupancy space to maintain alignment of the transition support with the docking structure platform. Such anchoring is preferably to the docking structure at a location that is preferably part of the docking structure. Once the vehicle is anchored to the occupancy space, or the docking structure, the vehicle door opens.

Alignment of the transition support and the docking structure platform, anchoring of the vehicle, and opening up the interior of the vehicle by the movement of one or more of the seat, steering wheel, and headrest described above configure the interior of the vehicle such that the interior of the vehicle body is now integrated to be a part of the occupancy space. Accordingly, in a preferred embodiment, the vehicle seat is now a occupancy space seat or a living space seat, and thus the interior of the vehicle, particularly the vehicle seat, may operate as a piece of furniture of the occupancy space, and the vehicle, particularly the interior of the vehicle is functionally and aesthetically part of the occupancy space.

Alignment as disclosed herein includes specific meanings, even though varying terminologies can be used throughout this disclosure. Generally, alignment can include sensor alignment, where sensors are aligned between the vehicle and the docking structure to establish a position of the vehicle, seat alignment, where a movable portion of a seat, which can include a portion of the transition support, is aligned with the docking structure or docking platform, a transition support alignment position, which can include alignment of a fixed portion of the transition support and a separate alignment of a movable portion of the transition support, including the seat, and vehicle alignment, which preferably occurs at transition support alignment. It should be understood that in some embodiments that sensor alignment, transition support alignment and vehicle alignment all occur simultaneously at the same position or location. In a preferred embodiment, transition support alignment occurs at the same time as vehicle alignment. In a more preferred embodiment, a movable portion of the transition support is aligned with the docking platform first, then a fixed portion of the transition support is aligned with the docking platform, at this position the vehicle is also aligned to the docking structure.

Transition support alignment is alignment of an upper surface of transition support 236 with an upper surface of docking platform 214 in an overlapping relationship when viewing docking platform 214 and transition support 236 from a direction transverse to a longitudinally extending centerline 98 of vehicle 14. In transition support alignment, the upper surface of transition support 236 is in an overlapping relationship or position with the upper surface of docking platform 214 such that an exposed exterior side or edge of transition support 236 is facing or opposed to an oppositely facing side of docking platform 214. Such alignment can include alignment of a vehicle anchor with a structure anchor, in which case vehicle 14 can be described as being in the vehicle alignment position with respect to the docking structure. Accordingly, transition support alignment and vehicle alignment with respect to the docking structure can be at a same position along the moving direction of vehicle 14 with respect to the docking structure.

In a more preferred embodiment, transition support alignment can include alignment of an interior or exterior front edge of transition support 236 with a front edge of docking platform 214. When the alignment of the interior or exterior front edge of transition support 236 is aligned with the front edge of docking platform 214, the structure anchor and the vehicle anchor can also be aligned and vehicle 14 can, accordingly, be described as being in the vehicle alignment position or location with respect to docking platform 214. When vehicle 214 is in the vehicle alignment position, a vehicle anchor and a docking structure anchor can be in an overlapping configuration or relationship to engage each other to maintain the alignment of transition support 236 with docking platform 214. Once transition support 235 is aligned with docking platform 214, upper surfaces of docking platforms 214 on opposite side of vehicle 14 with the upper surface of transition support 236 and seating surfaces of vehicle 14 form elongated seating or an elongated supporting surface beginning with each vehicle seat and extending along docking platforms 214, and that elongate seating surface is maintained by docking of vehicle 14 to the docking structure.

In an even more preferred embodiment, transition support alignment can include alignment of the upper surface of transition support 236, the upper surface of docking platform 214, and alignment of a moving portion of transition support 236. In a most preferred embodiment, the moving portion can be at a location that is transversely between the vehicle seat and the upper surface of the transition support. Further, the moving portion can be integrally formed as part of the vehicle seat and a specific portion of the moving portion can be aligned to, for example, a portion of docking platform 214 either during the transition support alignment process, during movement of vehicle 14 from a first position to a second position, or after movement of vehicle 14 to the vehicle alignment position, which can be described as a parked position and/or an anchored position.

As can be seen from the description hereinabove, Applicant recognized that improved vehicle safety, transition to electric vehicles, autonomous vehicle technology, and incorporation of other sophisticated technology into vehicles, such as connectivity and sensors, has transformed the vehicle into more than just a means of transportation. The vehicle's enhanced technology creates a quieter space with less burden on the driver and greater opportunity to enjoy the vehicle interior, structurally and functionally. Applicant recognized that the vehicle may be designed and utilized to be integrated to become part of the user's living experience beyond merely transportation. That is, Applicant appreciated that the interior or occupancy space of, as an example, a residential home, a commercial building, etc., or even a docking structure that is at least partially exterior to a building, and the vehicle can be configured to physically integrate in a manner that optimizes the user's spatial experience by allowing the interior of the vehicle to become part of the interior of the occupancy space or part of the docking structure. That is, by configuring an effective, seamless, and smooth integration of the vehicle with the occupancy space, and thus the occupancy space to the vehicle, the vehicle, including its interior space, becomes a part of the occupancy space, and the occupancy space becomes part of the vehicle, such that the vehicle can now be effectively used as part of the occupancy or living space as a kind of furniture, such as for eating, watching movies, communicating, etc. Integration of the vehicle into the occupancy space presents an opportunity for users to seamlessly and smoothly transition from a driving or riding environment in the vehicle to being in the occupancy space, and vice versa or the opposite, seamlessly transitioning from an occupied space of a building to a driving or riding environment in the vehicle. Further, the occupancy space and vehicle are configured to inter-operate to provide auto-parking and automatic reconfiguration of an internal space of the vehicle to provide ease of entry into, and egress from, the vehicle. The ultimate goal of such integration is harmonizing, or creating harmony between, the vehicle and the occupancy space to reduce the transition from transport or driving to occupying a space, i.e., an occupancy mode, and vice versa, which is inherently stressful, by improving the transition through a smooth reconfiguration of the interior of the vehicle to enhance integration of the vehicle with the structure. In other words, Applicant has been determined that the harmony of the vehicle with the structure reduces human stress regardless of whether the transition is from vehicle space to the occupancy space or the occupancy space to the vehicle space.

In the context of this disclosure, occupancy or occupation can mean for brief visits or stays, for longer visits or stays of many minutes or hours, or lengthy stays of multiple days. In other words, “occupancy or occupation” does not require human presence 24 hours a day, 7 days a week, for weeks on end, though the environment of an occupied space could be suitable for continuous occupation for hours to days and, in theory, years. For example, such areas can include an office, a living space in a home, an exercise area such as a gym or workout room, and other such areas within a building.

Many aspects of the disclosure are described in terms of sequences of actions to be performed by elements of a computer system or other hardware capable of executing programmed instructions, for example, a general-purpose computer, special purpose computer, workstation, or other programmable data process apparatus. It will be recognized that in each of the embodiments, the various actions could be performed by specialized circuits (e.g., discrete logic gates interconnected to perform a specialized function), by program instructions (software), such as program modules, being executed by one or more processors (e.g., one or more microprocessors, a central processing unit (CPU), and/or application specific integrated circuit), or by a combination of both. For example, embodiments can be implemented in hardware, software, firmware, microcode, or any combination thereof. The instructions can be program code or code segments that perform necessary tasks and can be stored in a non-transitory machine-readable medium such as a storage medium or other storage(s). A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents.

The non-transitory machine-readable medium can additionally be considered to be embodied within any tangible form of computer readable carrier, such as solid-state memory, magnetic disk, and optical disk containing an appropriate set of computer instructions, such as program modules, and data structures that would cause a processor to carry out the techniques described herein. A computer-readable medium may include the following: an electrical connection having one or more wires, magnetic disk storage, magnetic cassettes, magnetic tape or other magnetic storage devices, a portable computer diskette, a random access memory (RAM), a read-only memory (ROM), an erasable programmable read-only memory (e.g., EPROM, EEPROM, or Flash memory), or any other tangible medium capable of storing information. It should be noted that the system of the present disclosure is illustrated and discussed herein as having various modules and units that perform particular functions.

It should be understood that these modules and units are merely described based on their function for clarity purposes, and do not necessarily represent specific hardware or software. In this regard, these modules, units, and other components may be hardware and/or software implemented to substantially perform their particular functions explained herein. The various functions of the different components can be combined or segregated as hardware and/or software modules in any manner, and can be useful separately or in combination. Input/output or I/O devices or user interfaces including, but not limited to, keyboards, displays, pointing devices, and the like can be coupled to the system either directly or through intervening I/O controllers. Thus, the various aspects of the disclosure may be embodied in many different forms, and all such forms are contemplated to be within the scope of the disclosure.

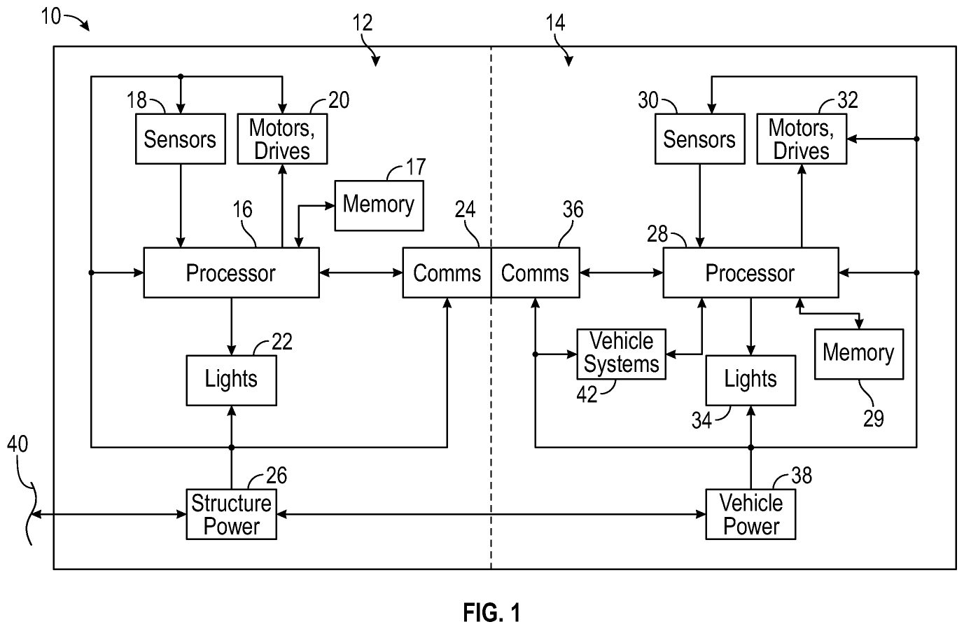

FIG. 1 shows a system level block diagram of an occupancy space vehicle integration system 10 in accordance with an exemplary embodiment of the present disclosure. Integration system 10 includes occupancy space 12 and vehicle 14.

Occupancy space 12 can be one of a plurality of rooms of a structure or building, or can be substantially an entire interior of a residential or commercial building, excluding divided areas such as closet(s), bathroom(s), and the like occupying a relatively small area of a structure. In exemplary embodiments, the room can be a living room, a family room, a workout room, a multipurpose room, an office, a library, and other rooms to the extent permissible by law. In another embodiment, occupancy space 12 may include a portion of an exterior of a structure or building. In other words, the structure platform described herein may extend longitudinally along or be alongside an exterior of a building. Such exteriors can include, for example, an outdoor activity or living space, such as a deck or patio.

Occupancy space 12 includes a plurality of interconnected systems, apparatuses, and devices. In an exemplary embodiment, such systems, apparatuses, and devices can include, for example, a structure processor 16, one or more structure sensors 18, a plurality of structure drives or motors 20, structure lights 22, structure communications 24, and structure power 26.

Vehicle 14 also includes a plurality of interconnected systems, apparatuses, and devices. In an exemplary embodiment, such systems, apparatuses, and devices can include, for example, a vehicle processor 28, one or more vehicle sensors 30, a plurality of vehicle drives or motors 32, vehicle lights 34, vehicle communications 36, vehicle power 38, and vehicle operation systems 42.

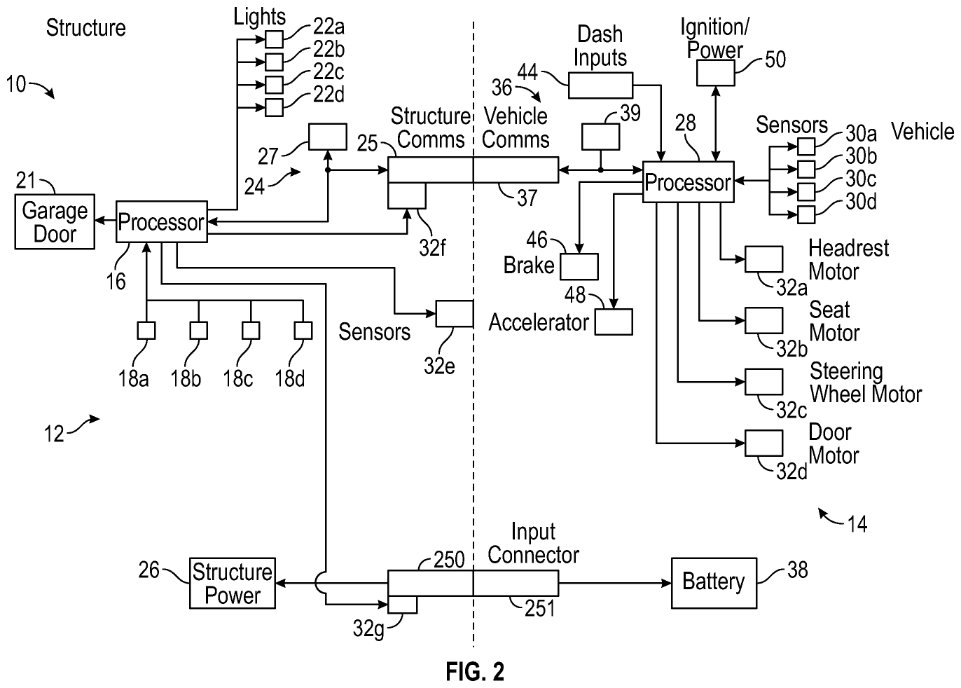

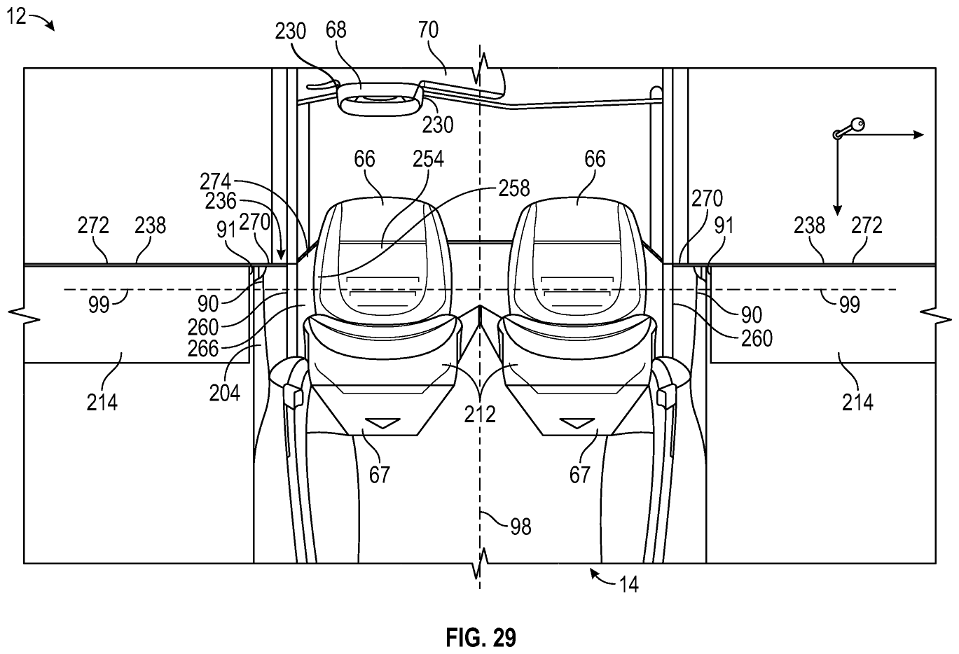

To aid in understanding the following discussion, and referring also to FIGS. 2, 14, 24, and 36-38, it should be understood that vehicle 14 can include a longitudinally extending vehicle body 500. In the context of vehicle 14, longitudinally extending means a front-back direction of vehicle 14. Accordingly, a direction that is away from longitudinally extending centerline 98 of vehicle 14 is a transverse direction 99 of vehicle 14 (e.g., see FIG. 29).

Vehicle body 500 includes or forms a vehicle interior or interior space 226, a vehicle exterior 502, which is any part of vehicle body 500 on an outside of vehicle body 500, and one or more vehicle openings 504. Vehicle body includes one or more vehicle doors 72 that are positioned to cover or uncover or expose a respective vehicle opening 504. Vehicle doors 72 move from a closed position that limits or prevents access to vehicle interior 226 through vehicle openings 504 to an open position to enable ingress and egress or access to and from vehicle interior 226 through or by way of vehicle openings 504.

Vehicle interior 226 provides space for a plurality of systems, hardware elements, and/or components, including operator controls 44, a brake operated by a brake pedal 46, an accelerator pedal 48, ignition 50, which can start or apply power to operate vehicle 14, a vehicle seat or seats 66, at least one seat headrest 67, a steering wheel 68, a vehicle dash or dashboard 70, an audio speaker 76, a microphone 78, and an input and display screen 84.

As shown in FIG. 1, structure processor 16, which can include a non-transitory machine readable memory, or which can be connected to a non-transitory machine readable memory 17, transmits outputs to various elements of occupancy space 12, and receives inputs from various elements of occupancy space 12. For example, processor 16 can receive signals from one or more structure sensors 18, and structure processor 16 can transmit control signals to structure motors and/or drives 20 and structure lights 22. In addition, structure processor 16 can establish two-way communication with vehicle 14 through structure communications 24. Structure communications 24 can include conventional systems and apparatuses such as a physical electrical connector to carry communication signals; an optical transmitter and receiver that transmit and receive communication signals, such as a fiber optic cable, a laser diode, or other optical sensors; a wireless transceiver such as Bluetooth, Wi-Fi, dedicated short range communications (DSRC), and/or IEEE 802.11 protocol; and cellular communication such as C-V2X. Broadly, these physical elements can be described as communications systems, apparatuses, or devices and while FIG. 1 appears to show that structure communications 24 is physically connected to vehicle communications 36, it should be understood that physically connecting structure communications to vehicle communications 36 is only one embodiment of communications between occupancy space 12 and vehicle 14.

Structure power 26 of occupancy space 12 provides power to each element of occupancy space 12 requiring power. For example, structure power 26 can provide power to structure processor 16, structure sensors 18, structure motors and drives 20, structure lights 22, and structure communications 24. Structure power 26 can include conventional local power, such as one or more batteries, solar cells, wind generation, power cells, a local generator, and the like located on, in, or adjacent to occupancy space 12, or structure power 26 can be received conventionally from an offsite power source 40, such as a power grid. It should be noted that vehicle power 38 can also provide supplemental power to structure power 26, and in the case where onsite power is generated, supplemental power from structure power 26 and/or vehicle power 38 can be supplied back to offsite power 40 to provide power to other users spaced away from occupancy space 12.

Also as shown in FIG. 1, vehicle processor 28, which can include a non-transitory machine readable memory, or which can be connected to a non-transitory machine readable memory 29, transmits outputs to various elements of vehicle 14, and receives inputs from various elements of vehicle 14. For example, vehicle processor 28 can receive signals from one or more vehicle sensors 30, and vehicle processor 28 can transmit control signals to vehicle motors and/or drives 32 and vehicle lights 34. In addition, vehicle processor 28 can establish two-way communication with occupancy space 12 through vehicle communications 36. Vehicle communications 36 can conventionally include a physical electrical connector to carry communication signals; an optical transmitter and receiver that transmit and receive communication signals, such as a fiber optic cable; a wireless transceiver such as Bluetooth, Wi-Fi, dedicated short range communications (DSRC), and/or IEEE 802.11 protocol; and cellular communication such as C-V2X. Broadly, these physical elements can be described as communications systems, apparatuses, or devices.

Vehicle power 38 of vehicle 14 provides power to each element of vehicle 14 requiring power. For example, vehicle power 38 can provide power to vehicle processor 28, vehicle sensors 30, vehicle motors and drives 32, vehicle lights 34, and vehicle communications 36. Vehicle power 38 can conventionally include one or more batteries, power cells, and the like located on or in vehicle 14. In addition, vehicle 14 can receive power by way of structure power 26 when vehicle 14 is parked and/or anchored to occupancy space 12.

It should be understood that each of occupancy space 12 and vehicle 14 can include a plurality of systems, apparatuses, and devices that are not directly related to integrating vehicle 14 with occupancy space 12. For the sake of clarity and simplicity, discussion of conventional features of occupancy space 12 and vehicle 14 is limited to those features that are part of the presently disclosed embodiments of occupancy space 12 and vehicle 14. Conversely, the lack of discussion of such features is only an indication that such features are not specifically part of the presently described embodiments, though they could be present in alternative embodiments. As an example, kitchen appliances are not generally discussed herein. However, various appliances could be actuated by the approach and presence of vehicle 14 in occupancy space 12. As another example, structure security devices such as alarms, a security communicator configured to transmit alerts to a monitored security location, sensors, and the like may be turned off or on as appropriate to approach of vehicle 14 and recognition, or the lack thereof, by occupancy space 12.

FIG. 2 shows a block diagram of occupancy space 12 vehicle integration system 10 of FIG. 1 in accordance with an exemplary embodiment of the present disclosure. As shown in FIG. 2, structure sensors 18 can include a plurality of structure sensors 18a, 18b, 18c, etc., and vehicle sensors 30 can include a plurality of vehicle sensors 30a, 30b, 30c, 30d, etc. Sensors 18 and 30 can include a variety of conventional sensors, for example, sound sensors, including ultrasound or ultrasonic sensors, optical sensors, including cameras, heat sensors, radar sensors, including LIDAR and LADAR, vibration sensors, proximity sensors, magnetic sensors, inertial sensors, and the like. Similarly, structure lights 22 can conventionally include lights for illumination, lights for accent or mood, and/or lights to provide an indication of vehicle integration state, such as approach, aligning, interfacing, docking, parking, and anchoring. Structure motors and drives 20 can include motors and drives such as a garage door or occupancy space door motor or drive 21. Structure motors and drives 20 can conventionally include electric motors, hydraulic pumps and motors, ball screw linear actuators, linear motors, chain drives, belt drives, gear reduction systems, and the like, which can include one or more anchor motors or actuators 32e, one or more electrical connector motors or actuators 32f, and a power electrical connector motor or actuator 32g. Vehicle motors and drives 32 can conventionally include motors and drives such as a head rest motor or motors 32a, a seat motor or motors 32b, a steering wheel motor or motors 32c, and a door motor or motors 32d, each of which are described in more detail hereinbelow. As with structure motors and drives 20, vehicle motors and drives 32 can conventionally include electric motors, hydraulic pumps and motors, ball screw linear actuators, linear motors, chain drives, belt drives, gear reduction systems, piezoelectric elements, bi-metal flexures, heat engines, internal combustion engines, transmissions, and the like. The term “drive” is intended to apply to any motive device that causes movement in a device, apparatus, mechanism, etc.

Other vehicle systems 42 can be accessed and controlled by vehicle processor 28. For example, during auto-docking and parking, described in more detail hereinbelow, vehicle systems 42 can include internal operator controls 44, vehicle brake pedal 46, vehicle accelerator pedal 48, and ignition/power switch or control 50.

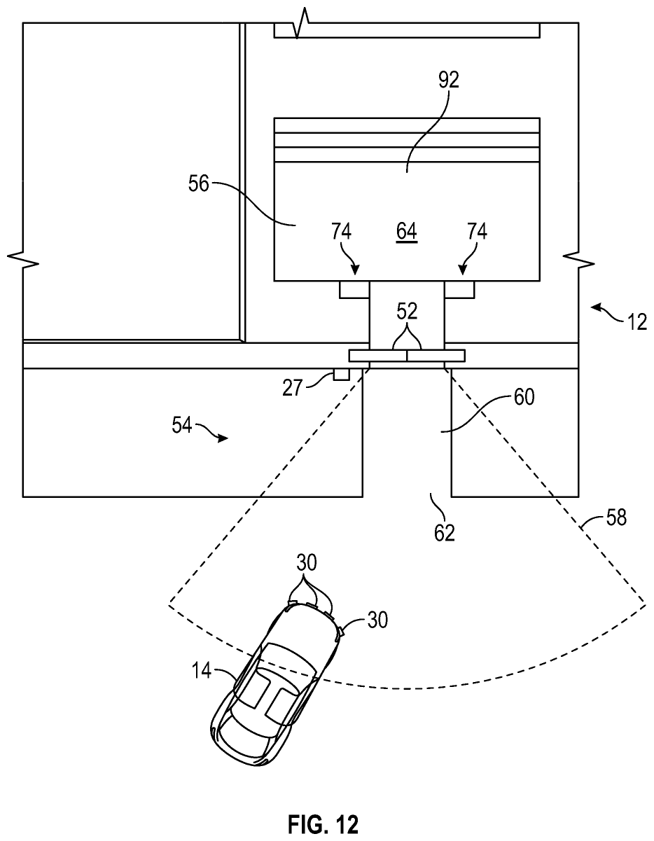

In FIG. 2, structure communications 24 includes a first communications device 25 and a second communications device 27. Also see FIGS. 12-14. First communications device 25 can be a conventional device or system such as a physical connector, an optical link, or other near-field communication device with a range extending from direct contact to being spaced apart by inches to a few feet. Second communications device 27 is a conventional wireless device, such as Wi-Fi, Bluetooth, dedicated short range communications (DSRC), IEEE 802.11 protocol, and the like, that can communicate over from feet to hundreds of feet.

Also, in FIG. 2, vehicle communications 36 includes a conventional third communications device 37 and a conventional fourth communications device 39. First communications device 37 can be a physical connector, an optical link, or other near-field communication device with a range extend from direct contact to being spaced apart by inches to a few feet that is configured to connect to first communications device 25 of occupancy space 12. Fourth communications device 39 is a wireless device, such as Wi-Fi, Bluetooth, dedicated short range communications (DSRC), IEEE 802.11 protocol, and the like that is configured to communication with second communications device 27.

Vehicle 14 integrates with a structure, docking structure 74, or occupancy space 12 through an integration process. Such integration process can be manual or driver controlled, semi-autonomous, with the driver performing some integration functions and vehicle processor 28 and/or structure processor 16 control some functions of vehicle 14, and fully autonomous, where vehicle processor 28 and/or structure processor 16 fully control movement of vehicle 14 alongside docking structure 74.

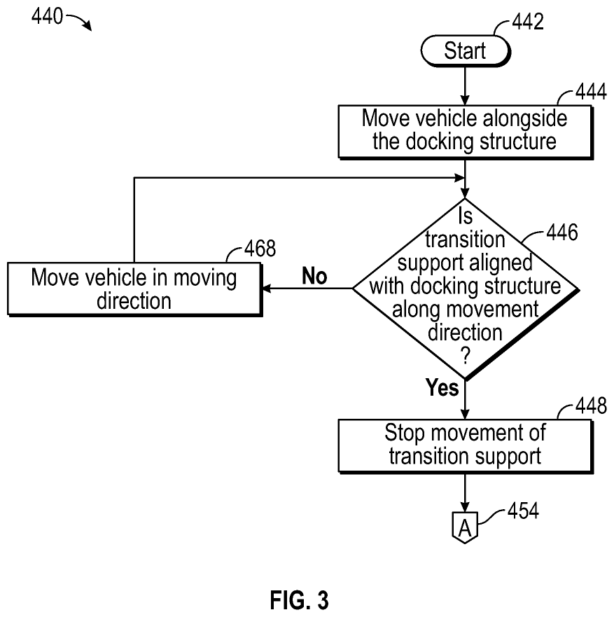

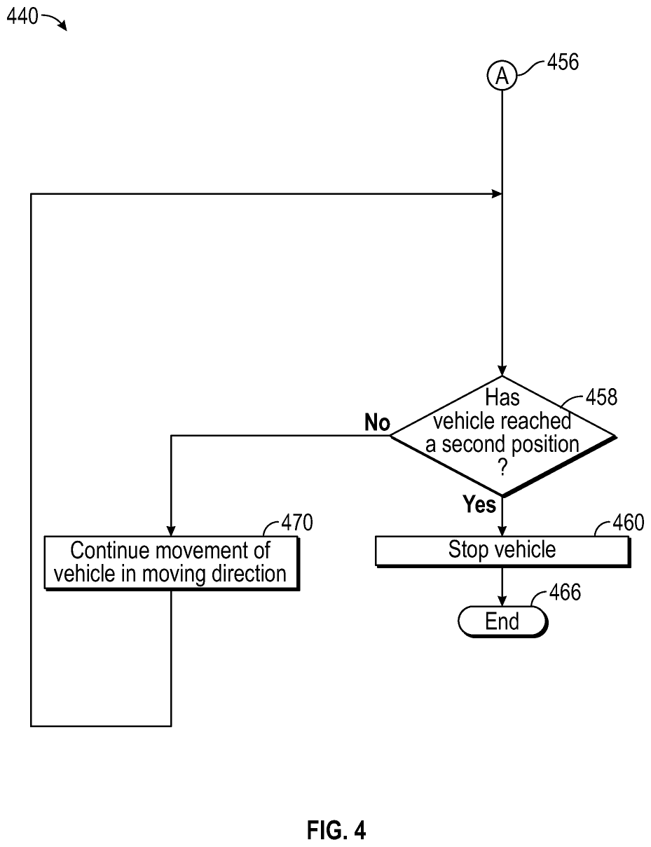

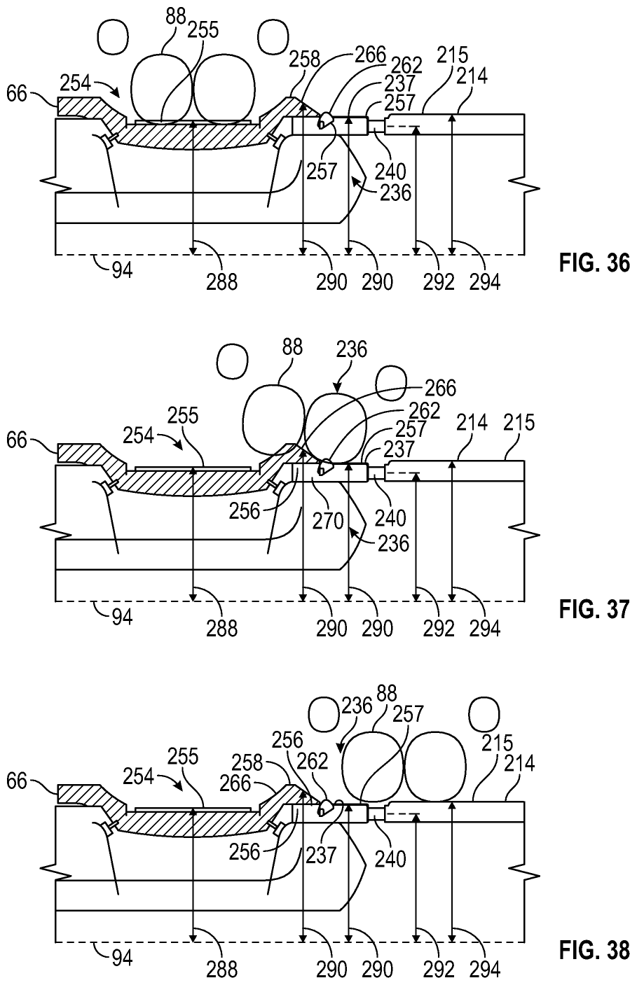

Turning to FIGS. 3 and 4, a first integration process 440 is shown. First integration process 440 describes an alignment process that operates to align vehicle transition support 236 with occupancy space 12 such that an upper, horizontally extending surface 237 of vehicle transition support 236 (e.g., see FIGS. 36-38), is aligned horizontally and vertically with an upper, horizontally extending surface 215 of a docking structure platform 214 (e.g., see FIGS. 36-38) at a support height in occupancy space 12 as part of integrating vehicle 14 with occupancy space 12. As described hereinabove, the alignment of transition support 236 with the docking structure platform enables smooth and easy movement of the user from vehicle seat 66 to docking structure platform 214, and upper surface 237 provides consistent vertical support of the user during movement of the user between vehicle interior 226 to vehicle exterior 502.

Transition support 236 can include many different embodiments. For example, in a preferred embodiment transition support 236 can include a single fixed piece having horizontally extending upper surface 237 that extends transversely to seat 66 and internally to vehicle opening 504 with an external outer end surface 271 that is exposed to the exterior of vehicle body 500, and more specifically to a space alongside or adjacent to vehicle 14 when vehicle door 72 is closed. In another preferred embodiment, upper surface 237 can extend through vehicle opening 504 to the exterior of vehicle body 500 into occupancy space 12. In yet another preferred embodiment, transition support 236 can be an extension of seat 66. In still yet another preferred embodiment, transition support 236 can be formed as part of seat 66, or attached directly to seat 66. In a further preferred embodiment, vehicle 14 can include a vehicle door that engages upper surface 237 to form a seal when the vehicle door is closed. In a further yet preferred embodiment, upper surface 237 can include a seal, including a seal formed in a groove, and the upper part of the seal can engage the vehicle door when the vehicle door is closed. In this preferred embodiment, the seal can be positioned such that transition support 236 has an interior or internal portion 256 to a first side of the seal and an external or exterior portion 257 to a second side of the seal.

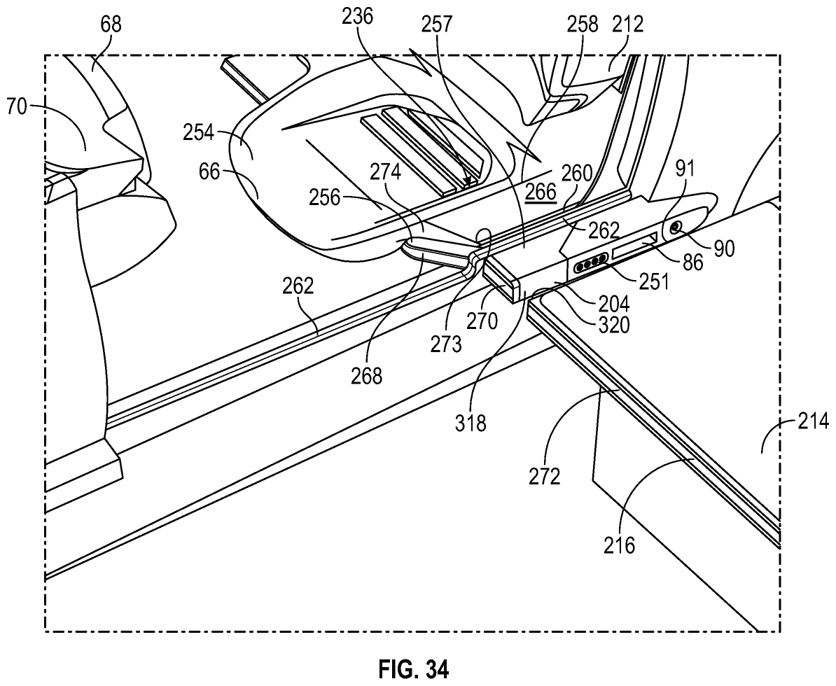

As described herein in reference to FIG. 34, in a preferred embodiment, transition support 236 is positioned adjacent to seat 66 at a location that is between seat 66 and vehicle door 72 and, accordingly, vehicle opening 504. In a preferred embodiment, transition support 236 includes a fixed transition support 256/257 and a movable transition support 266. Movable transition support 266 can be a piece separately formed and positioned in vehicle 14 or an extension of seat 66. Movable transition support 266 can also be separately formed and attached to seat 66. Fixed transition support 256/257 is fixed relative to vehicle 14. Movable transition support 266 is preferably movable relative to vehicle 14. Accordingly, movable transition support 266 is movable with respect to fixed transition support 256/257. Fixed transition support 256/257 includes a vertically extending front face or front edge 270 that can be external to vehicle body 500. However, front face or front edge 270 can also be internal to vehicle body 500. Fixed transition support 256/257 includes an exterior edge or face 318 that faces or opposes an outer edge or face of docking platform 214; e.g. see FIG. 32. Movable transition support 266 can be supported at least in part by fixed transition support 256/257. Movable transition support 266 can include a front face or front edge 274 that may be oriented at a non-perpendicular angle with respect to longitudinally extending centerline 98 of vehicle 14. Movable transition support 266 can also include a transversely facing edge 260 that intersects front face or front edge 274 at a front of transversely facing edge 260 at an intersection 273.

First integration process 440 can begin with a start process 442. In start process 442, various devices, apparatuses, mechanisms, and the like of occupancy space 12 and vehicle 14 can be powered, registers cleared, software started, and the like to initiate the equipment needed to integrate and interface vehicle 14 with occupancy space 12.

Once start process 442 is complete, control passes from start process 442 to a vehicle movement process 444 where vehicle 14 is moved alongside docking structure 74 in a direction that is parallel to the side surface of the docking structure that faces vehicle 14. Such movement is in the movement direction which is a direction that is a same direction as the longitudinal extent of the vehicle and includes movement from a road or parking area near to occupancy space 12 and/or docking structure 74 to an area at or within occupancy space 12 and alongside docking structure 74. Also see FIGS. 12-19, and the description of FIGS. 12-19 herein. As described in more detail hereinbelow, adjacent and alongside refers to being transversely next to docking structure 74 with a spaced distance, preferably a spaced distance within a maximum of two inches (50 millimeters), more preferably a spaced distance within a maximum of one inch (25 millimeters), even more preferably a spaced distance within a half inch (12.5 millimeters), even more preferably yet a spaced distance within a quarter of an inch (6 millimeters). As noted elsewhere herein, the transverse direction in the context of this disclosure refers to a direction that is cross-ways or away from longitudinally extending centerline 98 of vehicle 14 is a transverse direction of vehicle 14.

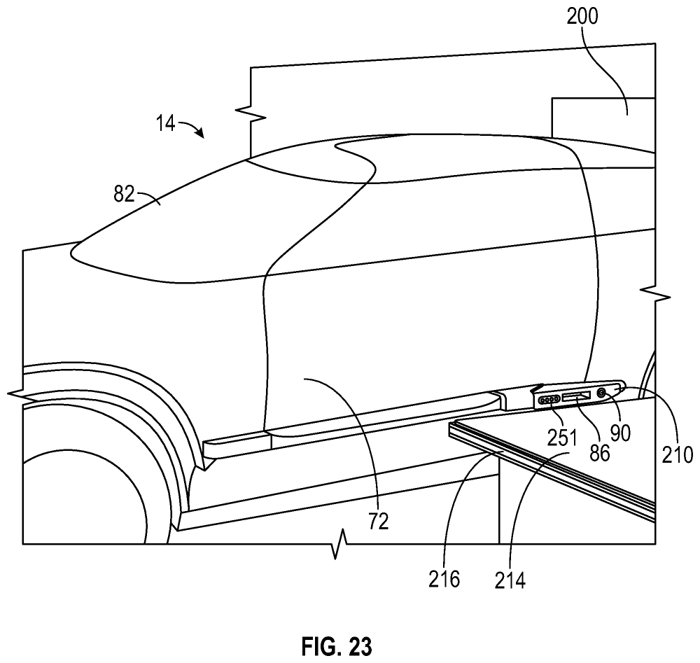

Once vehicle movement process 444 is initiated, control passes from vehicle movement process 444 to a transition support alignment decision process 446. In transition support alignment decision process 446, occupancy space 12 and vehicle 14 cooperate to determine whether transition support 236 on vehicle 14 is aligned with docking platform on occupancy space 12. Also, see FIGS. 23-25 and the associated description herein. Alignment of transition support 236 can be assisted by an alignment system, which can include at least one sensor, such as a vehicle sensor 90 or alignment sensor 174. The various sensors described herein, including sensor 90, sensor 91, sensor 93, and sensor 174, can include one or more conventional sensors such as a camera, a magnet and magnetic sensor, an optical emitter and receiver, a sonic or ultrasonic sensor, or other sensor configured to determine the proximity of a feature, which can also called a proximity sensor. It should be understood that an active sensor may only be present on vehicle 14, such as a camera, to determine when transition support 236 is aligned with structure platform 214, as described herein. Conversely, an active sensor may only be present in occupancy space 12 or on docking structure 74.

The position of docking structure platform 214 in occupancy space 12 relative to vehicle 14 can be determined in part by structure sensor 91, which is described in more detail herein. Alignment can be established by a sensor field of sensor 91 on occupancy space 12 or docking structure 74. In a preferred embodiment, transition support alignment is when transition support 236 on vehicle 14 is in a horizontal and vertical overlapping relationship with docking platform 214. In a preferred embodiment, transition support alignment is when transition support 236 is in an overlapping relationship with docking structure platform 214 horizontally and vertically within 1 inch (25 millimeters). In another preferred embodiment, transition support alignment is when transition support 236 on vehicle 14 is in an overlapping relationship with docking structure platform 214 horizontally and vertically within a half inch (12.5 millimeters). In a further exemplary embodiment, transition support alignment is when transition support 236 on vehicle 14 is in an overlapping relationship with docking structure platform 214 horizontally and vertically within a quarter of an inch (6.0 millimeters). If transition support 236 on vehicle 14 is not aligned with occupancy space 12, control passes to a moving direction process 468, where vehicle 14 continues to move in a moving direction alongside docking structure 74, or further moving vehicle 14 in the moving direction relative to docking structure platform 214 and movable transition support 266 after movable transition support 266 is aligned with docking structure platform 214, then returning control to transition support alignment decision process 446 until transition support 236 on vehicle 14 is aligned with docking structure 74. In a preferred embodiment, the front or forward facing face of transition support 236 is transversely aligned with the front face of the docking structure platform. Once transition support 236 on vehicle 14 is aligned with docking structure 74, and more specifically with docking platform 214, control passes from transition support alignment decision process 446 to fixed position process 448.

Returning to transition support alignment decision process 446, occupancy space 12 and vehicle 14 cooperate to determine whether transition support 236 on vehicle 14 is aligned with a docking platform 214 in occupancy space 12. If transition support 236 on vehicle 14 is not aligned with occupancy space 12, control passes to a moving direction process 468, where vehicle 14 continues to move in the moving direction alongside docking structure 74, then returning control to alignment decision process 446 until transition support 236 is aligned with docking structure 74. Once transition support 236 on vehicle 14 is aligned with docking structure 74, control passes from transition support alignment decision process 446 to an optional fixed position process 448.

In fixed position process 448, one or more features of vehicle 14 can remain fixed or non-moving relative to occupancy space 12 and/or docking structure 74. For example, at least part of transition support 236 may remain stationary with respect to docking platform 214 in occupancy space 12 as vehicle 14 continues to move in the movement direction. In addition, seat 66 can be configured to maintain a fixed relationship with respect to a fixed exterior location during movement of vehicle 14, which means that seat 66 moves relative to vehicle 14. Once one or more features of vehicle 14 are fixed with respect to occupancy space 12, control passes from optional fixed position process 448 to a position determination process 458, where it is determined whether vehicle 14 has reached a second, vehicle alignment position with respect to occupancy space 12.

In an exemplary embodiment, vehicle 14 is at the vehicle alignment position when upper surface 237 of transition support 236 is aligned with upper surface 215 of the docking structure platform, i.e., at the transition support alignment position. Preferably upper surface 237 is in the same plane, or approximately the same plane, as upper surface 215 of docking platform 214. In addition, transition support 236 is opposed to or alongside docking platform 214 along a line extending perpendicularly to longitudinally extending centerline 98 of vehicle 14. In this embodiment, when upper surface 237 of transition support 236 is aligned with upper surface 215 of docking structure platform 214 in transition support alignment decision process 446, there is no separate second position, and control passes from transition support alignment decision process 446 directly to a stop vehicle process 460, described hereinabove.

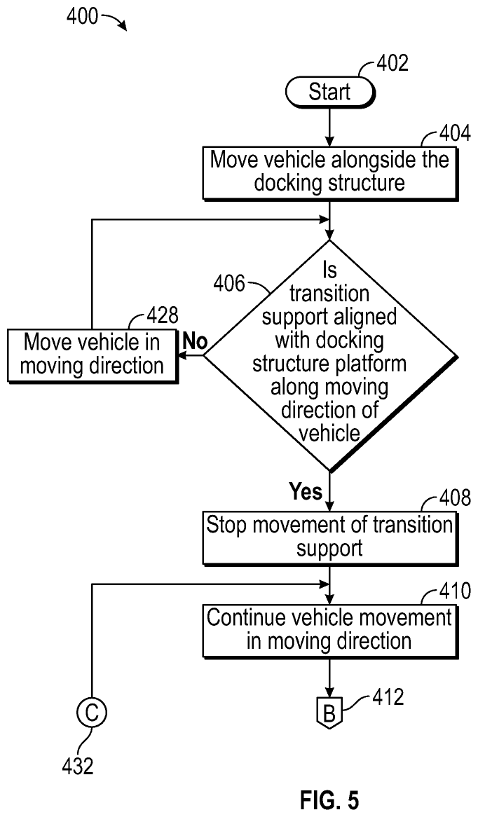

If there is a second position, the second position can be a predetermined distance, such as about 150 millimeters, from the first position. Alternatively, sensors located on vehicle 14 and/or occupancy space 12 can detect when vehicle 14 is at the second position. If vehicle 14 has not reached the second position, control passes to a moving direction process 470, where vehicle 14 continues to move in the moving direction alongside docking structure 74, then returning control to steering wheel retraction process 452, described hereinabove, by way of off-page connector 472 and on-page connector 474 in FIG. 5. It should be noted that vehicle 14 can continuously move as the movement of transition support 236, and in a preferred embodiment, movable transition support 266, is stopped and fixed relative to docking structure platform 214, which means that movable transition support 266 is moving relative to vehicle 14 at a same speed at which vehicle 14 is moving along the moving direction. On the other hand, if vehicle 14 has reached the second position, control passes to a stop vehicle process 460.

In stop vehicle process 460, vehicle 14 is stopped when transition support 236 is aligned with docking platform 214, as described hereinabove. In an alternative embodiment, a portion of transition support 236 is movable, and alignment of the fixed and movable portions of transition support 236 may occur when vehicle 14 is at the second position described hereinabove. As noted hereinabove, the second position can be an optional position if the position of fixed transition support 236 is used to determine vehicle alignment with docking structure 74. As noted herein, in a preferred embodiment the second position can be about 150 millimeters or about 6 inches from the first position. When vehicle 14 is stopped at the vehicle alignment position, several other things can happen at the same time. First, because vehicle 14 is no longer moving, movement of seat 66 and, if such exists, the moving portion of transition support 236 with respect to the second position in occupancy space 12 is stopped. Second, steering wheel 68 is fully retracted into vehicle dash 70. Accordingly, movement of steering wheel 68, i.e., retraction of steering wheel 68 into vehicle dash 70, is accomplished. Third, if any other components or systems of vehicle 14 are moving either as vehicle 14 moves to the vehicle alignment position or when vehicle 14 reaches the vehicle alignment position, such as headrest 67, such movement is also stopped. Once vehicle 14 and all movement within vehicle 14 to open or expand the internal space in vehicle 14 is stopped, control passes from stop vehicle process 460 to an end process 466, which terminates first process 440.

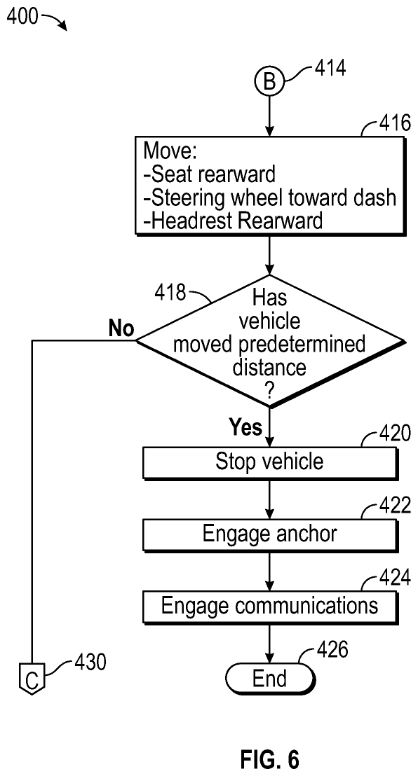

Turning next to FIGS. 5 and 6, a second integration process 400 is shown. Second integration process 400 describes an alignment process that operates to align vehicle 14 with occupancy space 12 such that an upper, horizontally extending surface 237 of vehicle transition support 236 (e.g., see FIGS. 36-38), is aligned horizontally and vertically with an upper, horizontally extending surface 215 of a docking structure platform 214 (e.g., see FIGS. 36-38) at a support height in occupancy space 12 as part of integrating vehicle 14 with occupancy space 12. As described hereinabove, the alignment of the transition support with the docking structure platform enables smooth and easy movement of the user from the vehicle seat to the docking structure platform.

Second integration process 400 is similar in many aspects to first integration process 440. Accordingly, processes of second integration process 400 having names identical with processes of first integration process 440 function substantially identically as the process of first integration process 440 and the description of those processes should be referenced for the following discussion.

Second integration process 400 can begin with a start process 402. In start process 402, various devices, apparatuses, mechanisms, and the like of occupancy space 12 and vehicle 14 can be powered, registers cleared, software started, and the like to initiate the equipment needed to interface and integrate vehicle 14 with occupancy space 12. Once start process 402 is complete, control passes from start process 402 to a vehicle movement process 404.

In vehicle movement process 404, vehicle 14 is moved in a movement direction, which can be described as a forward direction that is a direction that is generally parallel to a longitudinal extent of vehicle 14, alongside a docking structure such as docking structure 74 described in more detail herein. Such movement includes movement from a road or parking area near to occupancy space 12 and/or docking structure 74 to an area at or within occupancy space 12 and alongside docking structure 74. Also, see FIGS. 12-19, and associated description of FIGS. 12-19 herein. As described in more detail hereinbelow, adjacent and alongside initially refers to being transversely next to docking structure 74 within a maximum of two inches, preferably a maximum of one inch, even more preferably within a half inch, even more preferably yet within a quarter of an inch (6 millimeters). Transverse in the context of this disclosure refers to a direction that is cross-ways or perpendicular to a travel direction and/or a longitudinal extent of vehicle 14. It should be noted that the transverse direction does not specifically require the direction to be perpendicular to the direction of travel, but in a direction that is away from a line that defines the travel direction of vehicle 14, which could be longitudinally extending centerline 98 of vehicle 14.

It should be understood that vehicle movement process 404 is a dynamic process. In other words, movement of vehicle is toward occupancy space 12 and then alongside docking structure 74. Once vehicle movement process 404 is initiated, control passes from vehicle movement process 404 to a transition support alignment decision process 406.

In transition support alignment decision process 406, occupancy space 12 and vehicle 14 cooperate to determine whether transition support 236 is horizontally and vertically aligned with docking platform 214, as described hereinabove. In another preferred embodiment, a vertically extending surface of transition support 236 is aligned with a vertically extending surface on docking platform 214. As described herein in reference to FIG. 34, in a further preferred embodiment, transition support 236 includes fixed transition support 256/257 and movable transition support 266. Movable transition support 266 can be a piece separately formed and positioned in vehicle 14 or an extension of seat 66. Fixed transition support 256/257 is fixed relative to vehicle 14. Movable transition support 266 is preferably movable relative to vehicle 14. Accordingly, movable transition support 266 is movable with respect to fixed transition support 256/257. Fixed transition support 256/257 includes a vertically extending front face or front edge 270 that can be external to vehicle body 500. However, front face or front edge 270 can also be internal to vehicle body 500. Fixed transition support 256/257 includes an exterior edge or face 318 that faces or opposes an outer edge or face of docking platform 214; e.g. see FIG. 32. Movable transition support 266 can be supported at least in part by fixed transition support 256/257. Movable transition support 266 can include a front face or front edge 274 that may be oriented at a non-perpendicular angle with respect to longitudinally extending centerline 98 of vehicle 14. Movable transition support 266 can also include a transversely facing edge 260 that intersects front face or front edge 274 at a front of transversely facing edge 260 at an intersection 273.

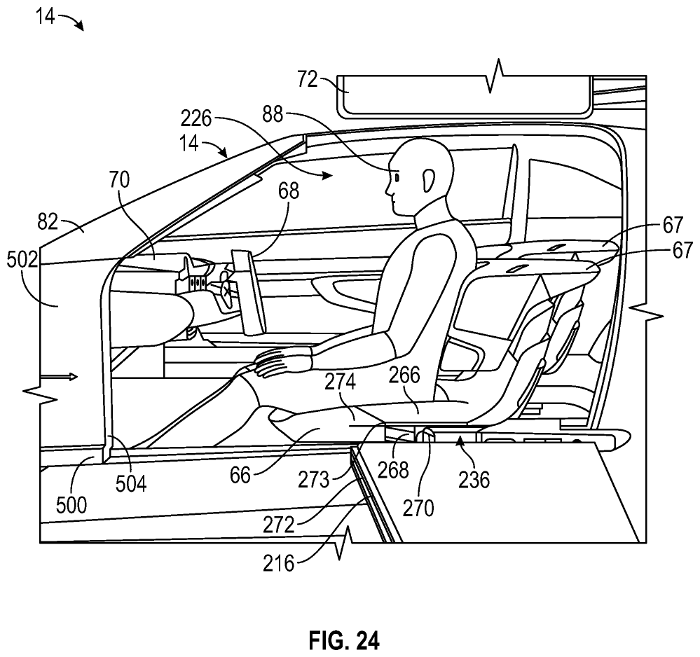

During transition support alignment process 406, front face or edge 270 is spaced rearwardly from intersection 273, as can be seen in FIG. 24. When intersection 273 is aligned along a line perpendicular to longitudinally extending centerline 98 of vehicle 14 with front face 272 of docking platform 214, transition support 236 is at a first alignment position and vehicle 14 is at a first position with respect to docking structure 74. Also, see FIGS. 23-25 and associated description herein. The alignment of intersection 273 with front face 272 of docking platform 214 along transverse direction 99 may be identified by a sensor, such as vehicle sensor 90 or alignment sensor 174, both of which are described in more detail herein. The alignment of front face 272 of docking platform 214 with intersection 273 along transverse direction 99 can be identified by a structure sensor 91, which is described in more detail herein. A sensor alignment position of vehicle 14 can be defined to be when the alignment sensor on vehicle 14 is within range of a sensor field of the mating alignment sensor on occupancy space 12 or docking structure 74 that defines the alignment of intersection 273 and front face 272 of docking platform 214. However, sensor alignment is generally an indication of alignment of some other features of vehicle 14, for example alignment of a vehicle seat or alignment of a transition support, including a movable portion of a transition support and/or a fixed position of a transition support. Accordingly, while sensor alignment or sensor detection may determine a position of seat alignment or transition support alignment, these positions are generally described in terms of seat alignment, movable transition support alignment, and/or transition support alignment rather than sensor alignment. In a preferred embodiment, alignment is when front face 272 of docking platform 214 is within 4 inches (100 millimeters) of a line extending perpendicular to longitudinal centerline 98, i.e., transverse direction 99, of vehicle 14 through intersection 273. In a further preferred embodiment, alignment is when front face 272 is within 2 inches of the line extending perpendicular to longitudinal centerline 98 through intersection 273. In a further preferred embodiment, alignment is when front face 272 is within 1 inch of the line extending perpendicular to longitudinal centerline 98 through intersection 273. In another preferred embodiment, alignment is when front face 272 of docking platform 214 is within a half inch (12 millimeters) of the line extending perpendicular to longitudinal centerline 98 of vehicle 14 through intersection 273. In a further preferred embodiment, alignment is when front face 272 of docking platform 214 is within a quarter of an inch (6.0 millimeters) of the line extending perpendicular to longitudinal centerline 98 of vehicle 14 through intersection 273. The closer intersection 273 and front face 272 are along a same line, the smoother the transition of the user from the vehicle to docking platform 214 from vehicle 14 and from docking platform 214 to vehicle 14.

If transition support 236 is not aligned with occupancy space 12, control passes to a moving direction process 428, where vehicle 14 continues to move in the moving direction alongside docking structure 74, or further moving vehicle 14 in the moving direction relative to docking structure platform 214 and movable transition support 266 after movable transition support 266 is aligned with docking structure platform 214, then returning control to alignment decision process 406 until front face 272 is positioned along the line that extends perpendicularly through intersection 273 (transverse direction 99) within the tolerances described herein, at which time the moving parts of transition support 236 are aligned with docking structure 74. Control then passes from alignment decision process 406 to fixed position process 408.

In fixed position process 408, portions of transition support 236 that are movable with respect to vehicle 14 can remain fixed or non-moving relative to occupancy space 12 and/or docking structure 74. In an exemplary embodiment, for example, as described in more detail herein, vehicle seat 66 remains fixed or non-moving relative to docking platform 214 in occupancy space 12 during further or continued movement of vehicle 14. One part of seat 66 may be a part of the transition support 236, described further herein. Accordingly, at least part of transition support 236 may remain stationary with respect to docking platform 214 occupancy space 12 as vehicle 14 continues to move in the movement direction. Once one or more features of vehicle 14 are fixed with respect to occupancy space 12, control passes from fixed position process 408 to a moving direction process 410, where vehicle 14 continues to move in the movement direction, similar to the function of moving direction process 428.

It should be understood that when vehicle 14 reaches the seat alignment position, vehicle 14 can either be stopped and restarted again after fixing the position of transition support of vehicle 14 with respect to the docking platform in occupancy space 12, or vehicle 14 can be continuously moving prior to seat alignment, at seat alignment, and after seat alignment at which point movement of movable transition support 266 is stopped relative to docking structure platform 214.

From moving direction process 410, control passes through off-page connector 412 in FIG. 3 to on-page connector 414 in FIG. 4 to a vehicle configuration process 416. In vehicle configuration process 416 several processes occur approximately simultaneously. It should be understood that “simultaneously” in the context of vehicle configuration process 416 in a preferred embodiment means in an overlapping relationship with respect to time of operation. In a further preferred embodiment, simultaneously means in an overlapping relationship of start and/or stop times of within two seconds, more preferably within one second, more preferably yet within a half second, even more preferably within a quarter of a second, and most preferably within a tenth of a second. The processes that occur simultaneously include movement of vehicle seat 66 rearward at the same speed that vehicle 14 moves forward, so that the effect is that the position of seat 66 appears to remain fixed with respect to occupancy space 12 and/or docking structure 74. In addition to the rearward movement of seat 66, a steering wheel, for example steering wheel 68 described herein, retracts toward a vehicle dash or dashboard, for example vehicle dash 70. In an exemplary embodiment, steering wheel 68 retracts toward vehicle dash 70 at a same rate that vehicle 14 moves forward from the first position, i.e., the transition support alignment position, which may also be a seat alignment position, to the second position, i.e., the anchor position. However, steering wheel 68 may retract at a rate that is faster, or slower, than forward movement of vehicle 14. In addition to the fixed position of seat 66 and the approximately simultaneous retraction of steering wheel 68, seat 66 includes headrest 67 that is described herein that moves rearwardly and swivels downwardly as vehicle 14 moves forward in simultaneous movement with the apparent rearward movement of seat 66 to maintain the fixed position with alignment platform 214 in occupancy space 12 and the retraction of steering wheel 68. In summary, during vehicle configuration process 416, as vehicle 14 moves forward from the aligned position with respect to docking platform 214, seat 66 moves rearwardly to remain in a fixed position relative to a fixed exterior location spaced away from vehicle 14, which is preferably a location on docking platform 214, steering wheel 68 retracts into vehicle dash 70, and headrest 67 swivels rearwardly and downwardly to smoothly open up an interior of vehicle 14 as vehicle 14 moves in the movement direction from the aligned position. Control then passes from vehicle configuration process 416 to a predetermined distance process 418.

In predetermined distance process 418, a determination of whether vehicle 14 has moved a predetermined distance is made. In an exemplary embodiment, the predetermined distance can be, for example, about 150 mm from the aligned position/location where the movable portion of transition support 236 is fixed with respect to docking platform 214. The predetermined distance is selected based on the dimensions of the vehicle, seat movement distance, the time required for motors to move systems within vehicle 14, and other similar factors that relate to a distance sufficient to permit opening of vehicle 14. It should be further noted that while vehicle speed can be reduced to increase the time for opening of vehicle 14, speeds below, for example, a quarter mile per hour may be deemed excessively slow from the user's perspective. Accordingly, the speed of opening should be matched to the user's perceived speed of vehicle 14 commensurate with the speed of opening to provide feeling of smooth integration. If vehicle 14 has not moved the predetermined distance, control passes through off-page connector 430 to on-page connector 432 in FIG. 3 and then to moving direction process 410. Once at moving direction process 410, operation of first integration process 400 continues as described herein above.

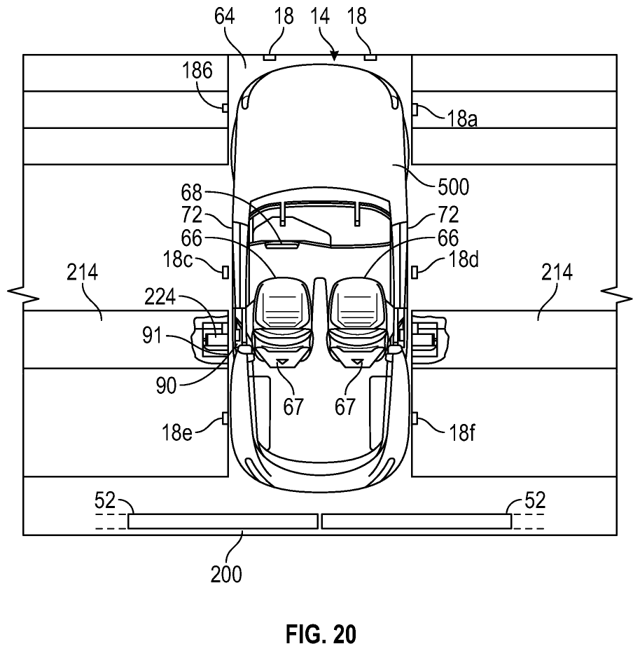

Returning to predetermined distance process 418, if vehicle 14 has moved the predetermined distance, control passes to a stop vehicle process 420. In stop vehicle process 420, vehicle 14 is stopped at the predetermined distance from the seat alignment position. As noted herein, the predetermined distance may be any distance sufficient to achieve opening of the vehicle, for example the predetermined distance can be about 150 millimeters or about 6 inches. When vehicle 14 is stopped, several other events also happen at the same time, simultaneously, or nearly simultaneously. First, because vehicle 14 is no longer moving, movement of seat 66 and the moving portion of transition support 236 with respect to docking platform 214 in occupancy space 12 is stopped. Second, steering wheel 68 should be fully retracted into vehicle dash 70. Accordingly, movement of steering wheel 68, i.e., retraction of steering wheel 68 into vehicle dash 70, ceases. Third, if any other components or systems of vehicle 14 are moving, such as headrest 67, such movement is also stopped. Once vehicle 14 and all movement of components within vehicle 14 being operated to open or expand the internal space in vehicle 14 is stopped, control passes from stop vehicle process 420 to an anchor process 422, at which time vehicle 14 is anchored to occupancy space 12, as shown in, for example, FIGS. 20, 27-29, and 30-33.

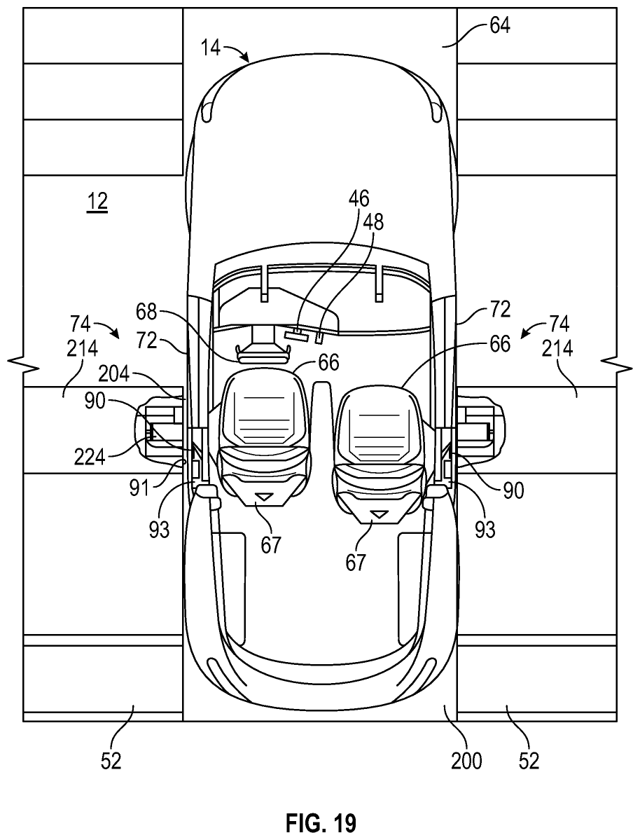

In an exemplary embodiment, the anchor includes structure anchor in occupancy space 12 and vehicle anchor on vehicle 14. One of the structure anchor and the vehicle anchor can be fixed and the other anchor can be movable to engage the fixed portion. Accordingly, the vehicle anchor can be fixed, i.e., non-moving, or the structure anchor can be fixed. Alternatively, the vehicle anchor can move to engage the structure anchor. As a further alternative, the structure anchor can move to engage the vehicle anchor. In a preferred embodiment, the structure anchor can be structure anchor 224 shown in FIG. 19 and the vehicle anchor can be a mating anchor receptacle 86. Once vehicle 14 is engaged to occupancy space 12 by the anchor, control passes from anchor process 422 to a communication process 424 where occupancy space 12 engages in communication with vehicle 14. In an exemplary embodiment, such communication is wireless. However, in another exemplary embodiment, such communication can be by way of a physical connection between occupancy space 12 and vehicle 14. Once communications are established between vehicle 14 and occupancy space 12, control passes to an end process 426, which terminates first process 400.

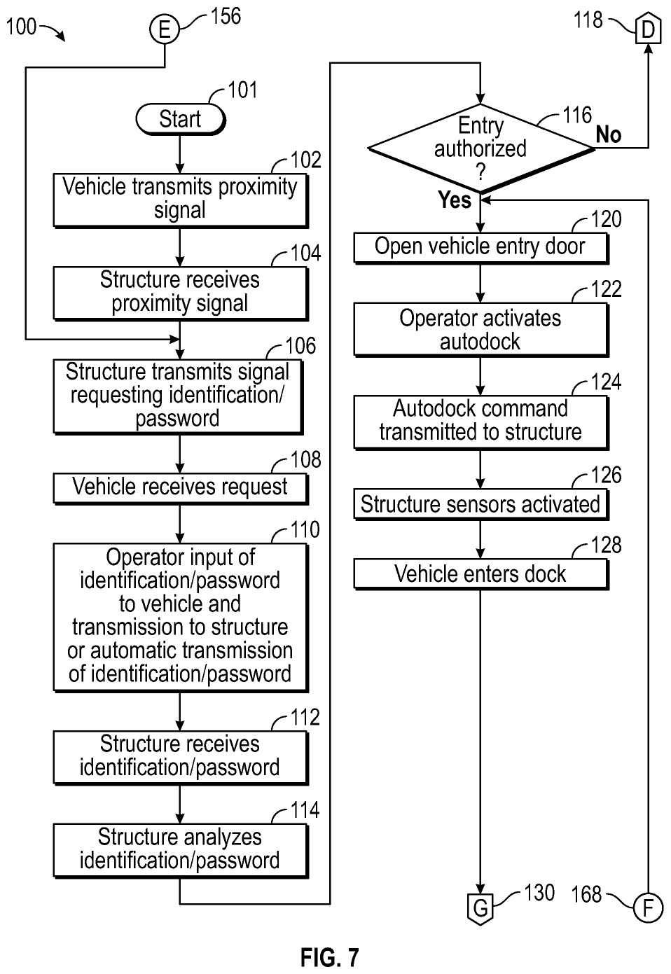

Turning next to FIGS. 7-10, a third integration process 100 is shown. Third integration process 100 describes an alignment process that operates to align vehicle 14 with occupancy space 12 such that an upper or upwardly facing, horizontally extending surface 237 of vehicle transition support 236 (e.g., see FIGS. 36-38), is aligned horizontally and vertically with an upper or upwardly facing, horizontally extending surface 215 of a docking structure platform 214 (e.g., see FIGS. 36-38) at a support height in occupancy space 12 as part of integrating vehicle 14 with occupancy space 12. As described hereinabove, the alignment of the transition support with the docking structure platform enables smooth and easy movement of the user from the vehicle seat to the docking structure platform.

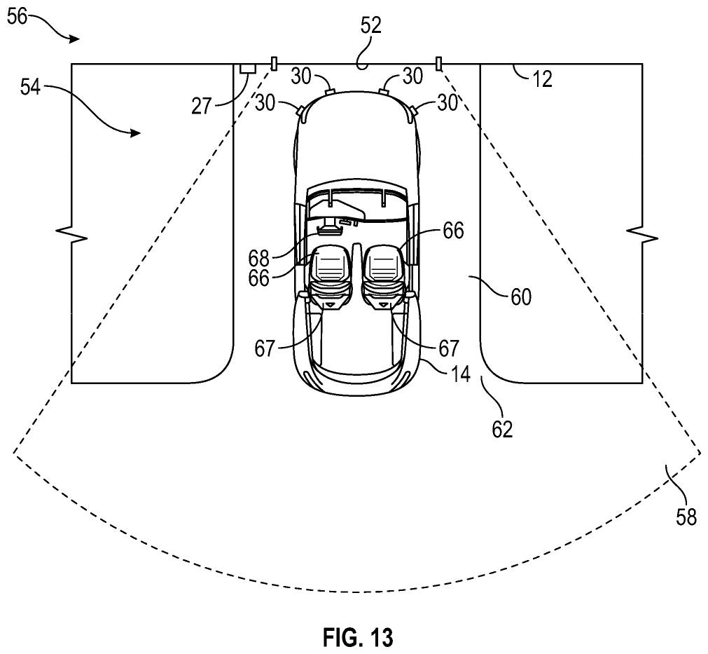

FIGS. 7-10 show third integration process flow 100 of occupancy space vehicle integration system 10 of FIG. 1 in accordance with an exemplary embodiment of the present disclosure. Process flow 100 outlines operations of vehicle 14 as shown in FIGS. 1, 2, and 14-57. Process flow 100 begins with a start process 101. In start process 101, which can occur, for example, when vehicle 14 is within a zone of approach 58, shown in FIGS. 12 and 13 and described in more detail hereinbelow, system 10 can be initialized. Such initialization can include providing power to sensors 18, lights 22, configuring structure communications to ping or seek out communication from vehicle 14, setting of variables and registers in structure processor 16 and vehicle processor 28, and the like. Once start process 101 is complete, control passes from start process to a proximity signal process 102.

In proximity signal process 102, vehicle 14 recognizes it is geographically within zone of approach 58. Vehicle processor 28, which can conventionally determine vehicle position from a GNSS system, a GPS system, a cellular phone network such as C-V2X, and/or by other conventional devices, sensors, apparatuses, and systems, transmits the position of vehicle 14 to structure communications 24 by way of vehicle communications 36. It should be noted that second communications device 27 of communications 24 would receive the position information in the exemplary embodiment of FIG. 2. Such transmission can occur automatically, or transmission can be initiated by approval of a vehicle operator through vehicle controls, discussed in more detail hereinbelow. Once vehicle 14 has transmitted a proximity signal to structure communications 24, control passes from proximity signal process 102 to a proximity signal receiving process 104.

In proximity signal receiving process 104, structure communications 24 receives the signal transmitted by vehicle communications 36. Structure communications 24 transmits the received signal to structure processor 16. Control then passes from proximity signal receiving process 104 to an identification request process 106.

Upon receiving the proximity signal from vehicle 14, structure processor 16 initiates an identification process, and transmits signals through structure communications 24 to vehicle communications 36 requesting identification of vehicle 14, which can include a password. Control then passes from identification request process 106 to an identification request received process 108.

In identification request received process 108, vehicle processor 28 receives the identification request from vehicle communications 36. Control then passes from identification request received process 108 to a vehicle identification process 110, in which vehicle processor 28 informs an operator of vehicle 14 that occupancy space 12 requests identification information. Vehicle processor 28 can inform the operator by way of audio signals through, for example, one or more speakers, through visual indication by the way of lights or displays on a dash or other vehicle systems, through a mobile communication device, such as a cellular phone, tablet, and the like, or through other systems. It should be noted that identification can be automatically set and provided by vehicle processor 28 autonomously without operator input. In a manual, verbal, or other entry by the operator, vehicle processor 28 receives the operator input, which is transmitted by way of vehicle communications 36 to structure communications 24. Control then passes from vehicle identification process 110 to a structure identification receipt process 112.

During structure identification receipt process 112, identification signals from vehicle 14 are received by, for example, second communications device 27, which is a wireless transceiver in the embodiment of FIG. 2 of structure communications 24. The signals received by structure communications are transmitted to structure processor 16, and control then passes from structure identification receipt process 112 to an identification analysis process 114, during which structure processor 16 analyzes the received identification signal to determine whether the received signal, which can include identification information and a password, conform to information stored in non-transitory memory connected to structure processor 16.

Control then passes from identification analysis process 114 to an entry authorized decision process 116, where structure processor 16 determines whether the identification information transmitted by vehicle 14 meets predetermined conditions for permitting entry of vehicle 14 into occupancy space 12. If entry authorized decision process 116 determines that entry into occupancy space 12 is authorized, control passes from entry authorized decision process 116 to an open entry door process 120.

In open entry door process 120, structure processor 16 transmits signals to one or more motors and/or drives 53 that are connected to door(s) 52. In the embodiment of FIG. 3, motor-drive 53 includes a motor drivingly connected to a conventional ball screw drive, commonly described as a ball screw linear actuator. Motor-drives 53 open door(s) 52 to permit vehicle 14 to enter occupancy space 12. Control then passes from open entry door process 120 to an auto-dock actuation process 122.

At this point in the process, at least two exemplary embodiments are disclosed. In one embodiment, the auto-dock sequence that is described hereinbelow is automatically or autonomously actuated by vehicle processor 28 without the need for the operator of vehicle 14 to grant permission. In this embodiment, sensors 18 and 30 determine whether any barriers to the auto-dock sequence exist, such as proximity of a human or pet that might be too close to vehicle 14. In addition, the auto-dock sequence may be disabled if one or both doors 72 to vehicle 14 are open, which could indicate a dangerous condition for occupants of vehicle 14.

In another embodiment, vehicle 14 can provide an alert via display screen 84 or by an audio alert by way of speaker 76 asking driver 88 whether driver 88 wishes to enter docking structure 74. In this embodiment, the operator or driver 88 of vehicle 14 affirmatively or positively activates or actuates the auto-dock sequence by input to a button or display/input screen 84, provides a specific verbal assent such as “engage auto-dock,” or provides a specific facial expression to a camera (not shown). Such activation or actuation can be by a button, including a displayed icon or “soft button,” by gesture, by an audible command such as “actuate auto-dock sequence,” by facial motions such as a predetermined sequence of blinks, and the like.

Once the auto-dock sequence command is given, either by the operator or by vehicle processor 28, control passes from auto-dock actuation process 122 to an auto-dock transmission process 124.

In auto-dock transmission process 124, vehicle processor 28 controls fourth communication device 39 to transmit the auto-dock sequence command to second communication device 27 of occupancy space 12. Second communication device 27 transmits the received auto-dock sequence command to structure processor 16. After receiving the auto-dock sequence command transmitted by vehicle 14, structure processor 16 activates structure sensors 18, and can also activate docking indication lights, discussed in more detail hereinbelow. Control then passes from auto-dock transmission process 124 to structure sensor actuation process 126.

During structure sensor actuation process 126, structure processor 16 actuates or activates sensors 18, which can include a plurality of sensors 18a, 18b, 18c, 18d, etc. Sensors 18 provide signals that include information regarding a distance to vehicle 14 to structure processor 16 as vehicle 14 enters a dock or docking space 64 located in occupancy space 12 in a subsequent vehicle dock entry process 128. Structure processor 16 can use the distance information to determine an orientation of vehicle 14 in a longitudinal direction, i.e., a direction along a path of travel into dock space 64, and in a transverse direction, i.e., a direction crossways or perpendicular to the longitudinal direction. It should be understood that the longitudinal extent direction of vehicle 14 is the front-back direction of vehicle 14 along longitudinally extending centerline 98 of vehicle 14, and a transverse direction of vehicle 14 is the transverse direction 99 that is crossways or perpendicular to the longitudinal direction. It should also be understood that as described elsewhere herein, on-vehicle sensors can provide all the sensing required to move vehicle 14 into dock space 64. However, the presence of sensors in dock space 64 may enable docking of vehicles without the sensors capable of orienting vehicle 14 in dock space 64. In addition, the presence of sensors in dock space 64 may provide the ability to confirm the orientation data of vehicle sensors to provide increased accuracy and position of vehicle 14 in dock space 64 with respect to docking structures 74.

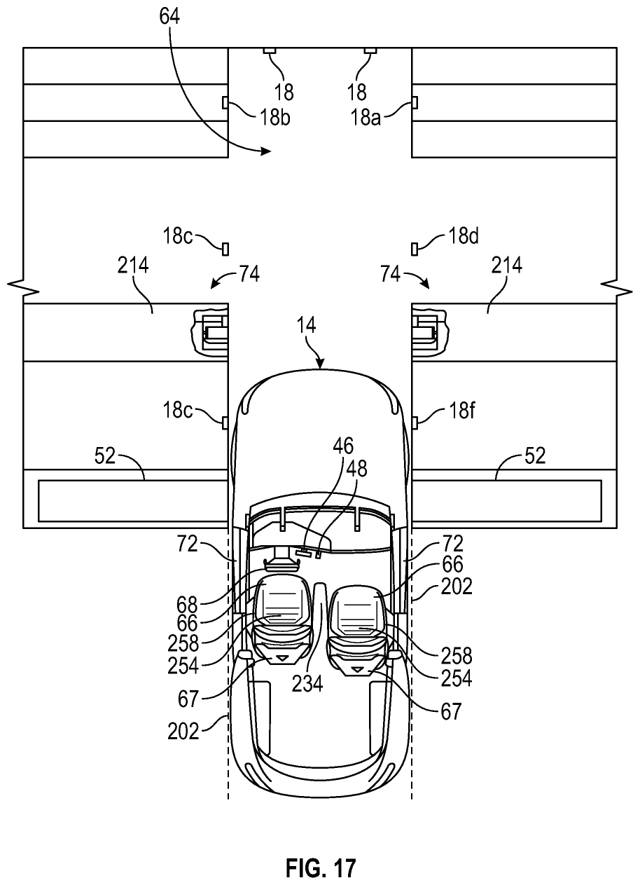

In an exemplary embodiment, structure processor 16 transmits correction information to vehicle processor 28 of vehicle 14 by way of structure second communication device 27 and vehicle fourth communication device 39. For example, referring to FIG. 17, if sensor 18e indicates a spaced distance to vehicle 14 of three inches, and sensor 18f indicates a spaced distance to vehicle 14 of five inches, structure processor 16 is configured to transmit a correction of one inch transversely or laterally in a direction toward sensor 18f. Further, referring to FIG. 20, if sensor 18c indicates that a distance to vehicle 14 is three inches, sensor 18d indicates that a distance to vehicle 14 is five inches, sensor 18e indicates a distance to vehicle 14 of one inch, and sensor 18f indicates a distance to vehicle 14 of seven inches, then vehicle processor 28 is configured to modify steering of vehicle 14 to adjust the transverse position of vehicle 14 to center vehicle 14 between sensors 18c and 18d and between sensors 18e and 18f, which also adjusts an angle of orientation of vehicle 14 with respect to a longitudinal direction of travel of vehicle 14.

In another exemplary embodiment, structure processor 16 transmits distance information from each sensor of the plurality of sensors 18 to vehicle processor 28 of vehicle 14 by way of structure second communication device 27 and vehicle fourth communication device 39. Vehicle processor 28 then uses the distances to adjust steering to center vehicle 14 in dock space 64, simultaneously adjusting the longitudinal direction of vehicle 14 with a longitudinal center of dock space 64.

After actuation of structure sensors 18, control is passed from structure sensor actuation process 126 to dock entry process 128. It should be understood that dock entry process 128 can be initiated by vehicle 14 independent of any acknowledgement signal from structure processor 16 transmitted via second communications device 27. Conversely, if there is a fault in any system, device, or apparatus of occupancy space 12 that is required to accomplish the auto-dock sequence, structure processor 16 can transmit an abort signal (not shown in process 100) via second communication device 27 to fourth communication device 39 of vehicle 14, which is then transmitted to vehicle processor 28. Vehicle processor 28 can then halt movement of vehicle 14 into occupancy space 12, and display an indication to the operator of vehicle 14 of a system fault.

In dock entry process 128, vehicle 14 enters dock space 64, using information from structure sensors 18 and from vehicle sensors 30 to position longitudinal centerline 98 of vehicle 14 along a centerline of dock space 64, at an angle of longitudinal centerline 98 that is as close to parallel with the centerline of dock space 64 as possible.

As vehicle 14 is controlled by dock entry process 128, a vehicle speed is reduced to about 2 mph or increased to about 2 mph, depending on whether vehicle 14 was in a driving mode or stopped prior to engaging auto-dock. It should be understood that the speed of vehicle 14 entry can be higher or lower than 2 mph. For example, the entry speed can be in a range of 0.25 mph to 4.00 mph. In another exemplary embodiment, entry speed can be in a range of 0.25 to 3 mph. In yet another exemplary embodiment, entry speed can be in a range of 1 to 3 mph. In a still further exemplary embodiment, entry speed can be in a range of 0.5 to 2.5 mph. Further, any range within 0.25 mph to 4.00 mph can be used as an exemplary entry speed range. As the speed of vehicle 14 increases during entry into dock space 64, the risk of being unable to stop vehicle 14 in the event of an unsafe condition decreases. Accordingly, the speed of vehicle 14 should preferentially be less than 4 mph, and even more preferentially should be less than 2 mph. On the other hand, operation at speeds below 0.25 mph may be perceived as being excessively slow by the occupants of the vehicle. Accordingly, vehicle speeds in a range of 0.25 mph to 2 mph are preferred as a balance between safety and user perception.

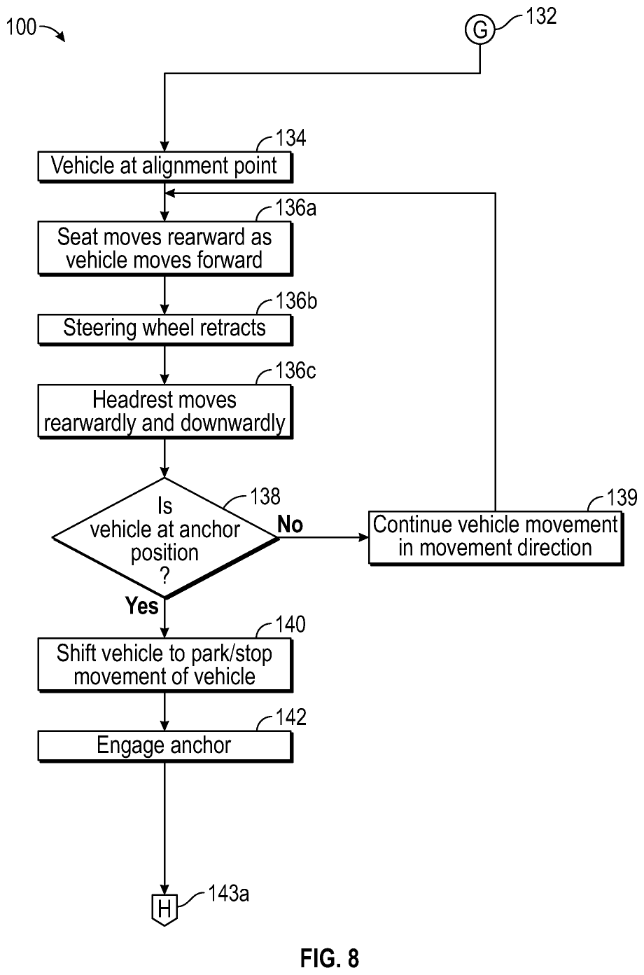

In an exemplary embodiment, as vehicle 14 enters dock space 64, vehicle processor 28 drives head rest motors 32a to move seat head rests 67 from an upright position to a lowered position to increase the space available for driver and passenger to exit vehicle 14 and to increase freedom of head movement for visibility. Dock entry process continues until vehicle 14 reaches a seat alignment position in dock space 64. The seat alignment position can be considered a first position of vehicle 14 in occupancy space 12. Once vehicle 14 reaches the seat alignment position, control passes from dock entry process 128 through off-page connector 130 to on-page connector 132 in FIG. 8 and then to transition support alignment process 134.

Transition support alignment process 134 operates to align transition support 236 with occupancy space 12 such that transition support 236 is aligned horizontally and vertically with docking structure platform 214 at a support height in the occupancy space to integrate vehicle 14 with occupancy space 12. In other words, the support height on vehicle 14 at upper surface 237 of transition support 236 is approximately at the support height of upper surface 215 of platform 214. Further, upper surface 237 of transition support 236 and upper surface 215 of platform 214 are approximately in the same plane, which is at or above the seating height of the seat. The seating height is a height of an upper seating surface 255 of the vehicle seat at a location where a posterior of the user is supported. It should be noted that a seat bottom can be tilted from a location where the user's bottom is supported. Accordingly, the seating height in a preferred embodiment is the lowest point of seat 66 where the user's bottom is supported, particularly when seating surface 255 is tilted in a forward-back direction of vehicle 14. In a preferred embodiment upper surface 237 of transition support 236 is co-planar with upper surface 215 of platform 214. It should be understood that the alignment between vehicle 14 and occupancy space 12 is at the support height. In the context of this disclosure, approximately for height of the seating height can be in a range of plus or minus two inches or 50 mm. In a preferred embodiment, approximately is in a range of plus or minus one inch or 25 mm. In a still more preferred embodiment, approximately is in a range of plus or minus one half inch or 12.5 mm. In an even more preferred embodiment, approximately is in a range of plus or minus a quarter inch or 6 mm.

As described herein, transition support 236 can include an internal portion and a contiguous external portion. In an exemplary embodiment, the internal portion can be transition support 256, and the contiguous external portion can be external transition support 257. Transition support 236 also includes upwardly facing upper surface 237, as described herein. Upper surface 237 extends across at least the interior portion of transition support 236, and can extend across the exterior portion of transition support 236. Vehicle body 500 includes a seal positioned directly between vehicle door 72 and transition support 236 when vehicle door 72 is closed. In a preferred embodiment, the seal is positioned on vehicle door 72 and the seal contacts or engages upper surface 237 to form a seal between interior space 226 of vehicle body 500 and the exterior of vehicle body 500. Accordingly, when vehicle door 72 engages upper surface 237 of transition support 236, the engagement forms a seal, and since the seal is at upper surface 237, the seal is at the support height. In another preferred embodiment, transition support 236 includes a groove 264 the extends downwardly from upper surface 237, and seal 262 is positioned partially in groove 264 and extends a spaced distance above upper surface 237 such that an upper or upwardly facing surface of seal 262 is part of the upper surface of transition support 236. In this embodiment, seal 262 engages a lowermost or downwardly facing surface of vehicle door 72 to form a seal between interior space 226 and the exterior of vehicle body 500.

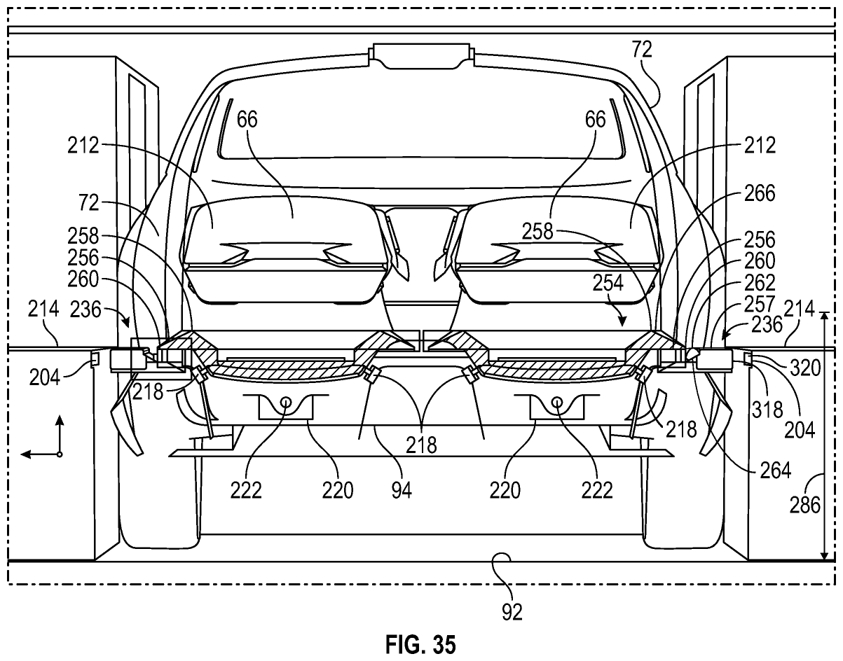

Transition support 236 is positioned directly between interior 226 of vehicle 14 and docking structure 74, including platform 214. In addition, internal transition support 256 extends horizontally from seat 66 toward exterior 502 of vehicle body 500 and vehicle 14, and external transition support 257, which extends horizontally away from vehicle 14, are each fixed with respect to vehicle 14 and with respect to each other. In the exemplary embodiment of FIG. 35, internal transition support 256 is directly and contiguously attached to external transition support 257. It should be apparent that in this embodiment, door seal 262 is at a dividing line or location between the exterior part of transition support 236 and the interior part of transition support 236. Accordingly, door seal 262, which can have a segment or section on the exterior side and a segment or section on the interior side, can simultaneously be part of internal transition support 256 and exterior transition support 257. Transition support 236 can also include a movable transition support 266, which can be formed as a part of seat 66. While movable transition support 266 can move relative to internal or interior transition support 256 and external transition support 257, once vehicle 14 is at the transition support alignment position, which in a preferred embodiment is the vehicle parked position, movable transition support 266 is fully supported by internal transition support 256 to enable movement of driver 88 from and to seat 66 to docking structure 74, and more particularly to platform 214 of docking structure 74.

In an exemplary embodiment, such as that of FIG. 35, internal transition support 256 and external transition support 257 are formed of a single, contiguous piece, and door seal 262 is positioned in groove 264 formed in an upper or top surface of transition support 236. When doors 72 are closed, a bottom edge of a respective door 72 contacts, interfaces, or engages with a respective door seal 262 to provide an environmental seal between exterior 502 and interior 226 of vehicle 14. Since door seal 262 is part of transition support 236, door 72 contacts transition support 236 when door 72 is closed, which can be seen in FIG. 35. Since door 72 engages door seal 262, and since transition support 236 includes seal 262, then a lower edge of door 72, which in an exemplary embodiment can be a lowermost edge of door 72, engages a top surface of transition support 236 to form a seal at a height of transition support 236 above a ground level, such as floor 92 of dock space 64, which can be described as the support height.

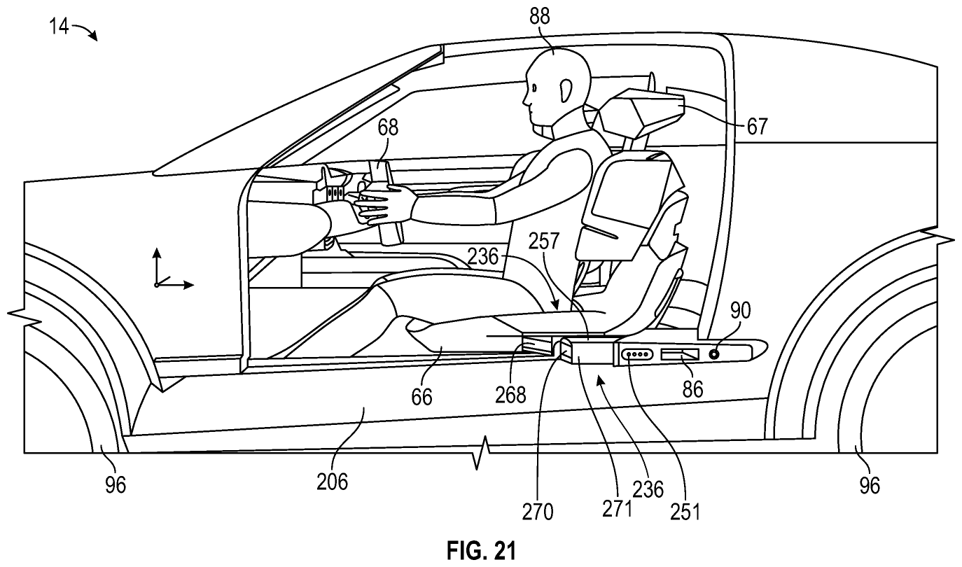

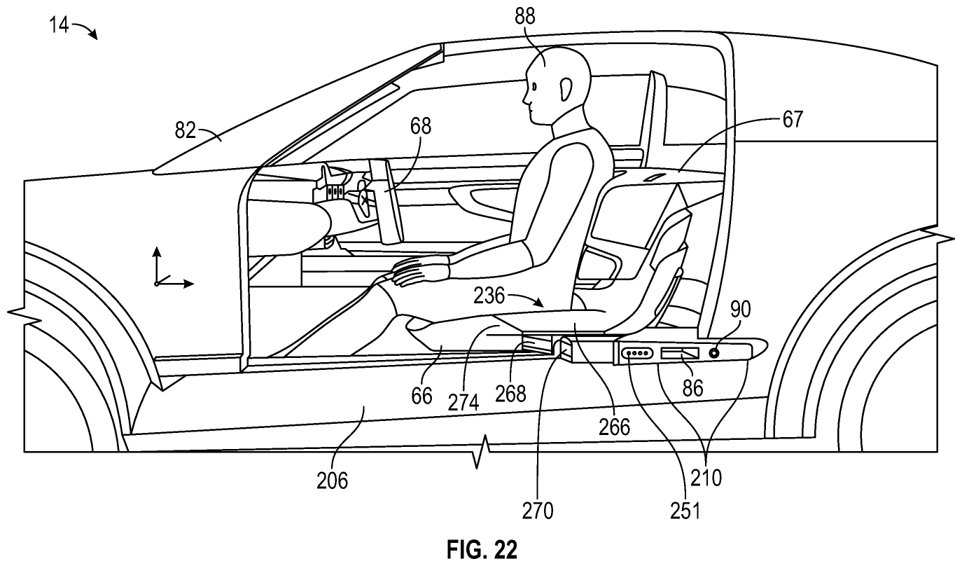

As shown in FIGS. 21 and 22, internal transition support 256 includes a front edge or face 268. Front edge 268 is longitudinally a part of internal transition support 256 that is at a face of internal transition support 256 that faces toward a front of vehicle 14. External transition support 257 includes a front edge or face 270 that is at a face of external transition support 257 that faces toward the front of vehicle 14. It should be understood that front edge 268 is preferably co-planar with front edge 270, and front edge 268 can be a continuation of front edge 270 and vice versa. External transition support 257 also includes outer end surface 271 that is exposed to the space alongside vehicle 14, i.e., to exterior 502 of vehicle 14, when door 72 is closed. The position of front face 268 and front face 270 helps to determine when transition support alignment occurs and when anchoring occurs, as discussed further hereinbelow.

As described herein, the sensor alignment position is a physical location in occupancy space 12 that contains sensor 91, which can be, for example, a combination of a transmitter and receiver, a sensor, or other device. The sensor alignment position is a fixed reference point in occupancy space 12 from which the transition support alignment position, which can be described as a second predetermined position or second position relative to the first position, which is the sensor alignment position, can be determined. However, since sensor alignment or sensor detection is for the purpose of aligning a portion of seat 66, the sensor alignment position is preferably described as the seat alignment position since alignment of a sensor or detection of a specific location on docking structure 74 is less important than determining the position of seat 66 with docking structure platform 214. During transition support alignment position process 134, vehicle 14 moves longitudinally into dock space 64. Vehicle sensor 90 faces in a direction that is perpendicular to the longitudinal direction of vehicle 14, which means that as vehicle 14 moves into dock space 64 or alongside docking structure 74, vehicle sensor 90 moves with vehicle 14. Vehicle sensor 90 seeks fixed sensor 91, or a marker or visually identified location on docking structure 74, until vehicle sensor 90 and sensor 91 are opposed to each other, opposite to each other, or in an overlapping relationship with each other across a spaced distance in an elevation view of vehicle sensor 90 and structure sensor 91 that is perpendicular to a longitudinal or front-back direction of vehicle 14, and the overlap or opposition of sensors 90 and 91 in transverse direction 99 is one determination of the seat alignment position in dock space 64.

At least one of the vehicle alignment apparatus and the occupancy space alignment apparatus includes a feedback apparatus to indicate alignment, and that information is transmitted to at least vehicle processor 28 and is preferably transmitted to structure processor 16. As will be described further hereinbelow, when transition support 236 is aligned docking platform 214, the support height of vehicle 14 is aligned with a support height of docking platform 214 in occupancy space 12.

In addition, when vehicle 14 is aligned to platform 214, in a preferred embodiment transition support 236 is aligned along a longitudinal direction, i.e., in a forward/reverse direction, such that front face 270 of external transition support 257 is aligned to a front face or edge 272 of platform 214. Further, the transition support alignment process aligns an upper surface of external transition support 257 and an upper surface of platform 214 vertically, which may be inherently aligned by the design of vehicle 14 and docking platform 214. Accordingly, external transition support 257 is aligned horizontally and vertically with platform 214, which can be seen in FIGS. 29, 34, and 35.

In an embodiment, seat 66 includes movable transition support 266 that is supported at least in part by internal transition support 256 (e.g., see FIG. 35). Movable transition support 266 extends transversely or laterally from seat 66 at an outermost side of seat 66, adjacent to a bucket edge 258, transversely or laterally being in a direction that is perpendicular to the longitudinal or front-back direction of vehicle 14. In an exemplary embodiment, movable transition support 266 can be integral, or formed as a single piece with seat 66. In another exemplary embodiment, movable transition support 266 can be an attachment to seat 66.

Movable transition support 266 includes a front face 274 (e.g., see FIG. 22) that faces toward the front of vehicle 14. When vehicle 14 is at the seat alignment position, front face 274 can be positioned further forward from front face 268 of internal transition support 256 and from front face 270 of external transition support 257 by approximately 150 mm or about 6 inches.

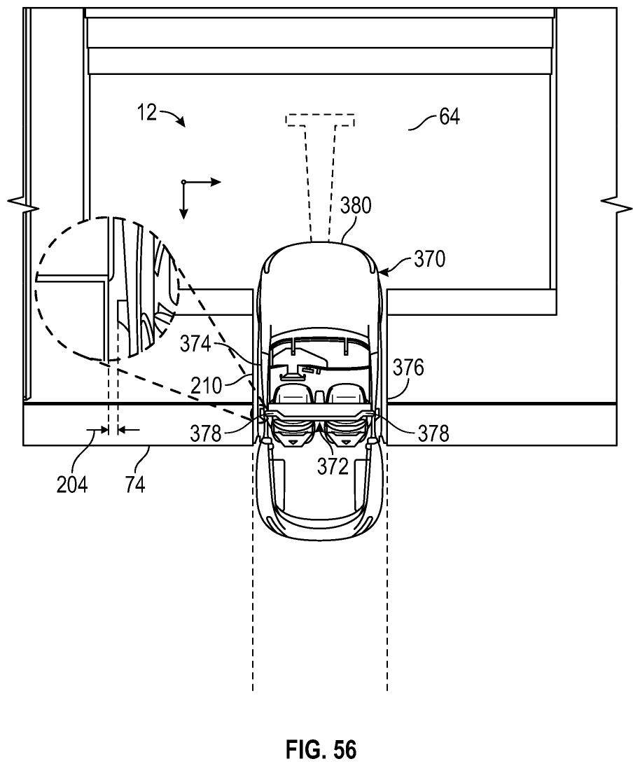

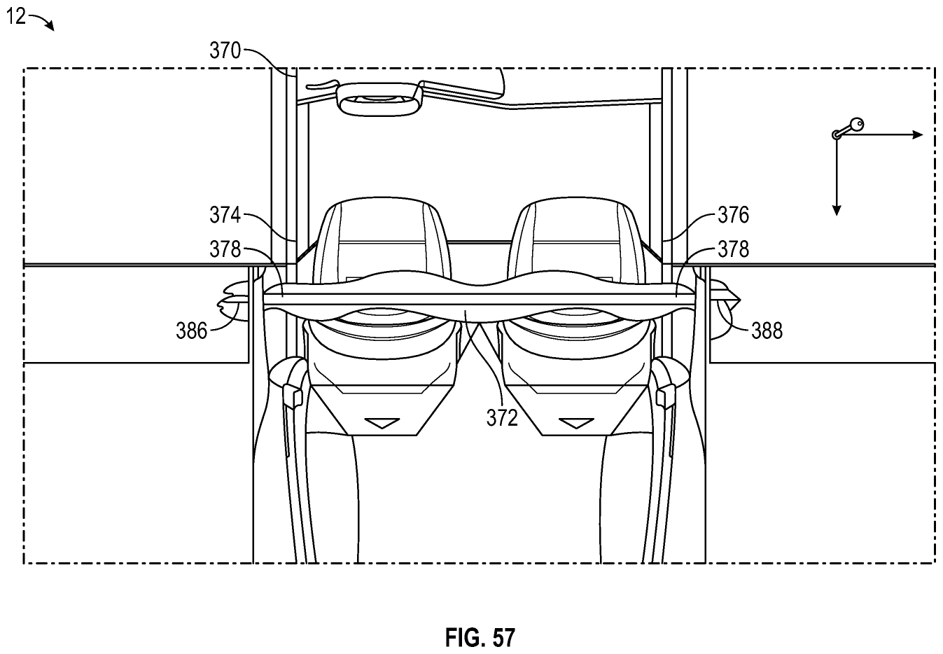

While vehicle sensor 90 can include a transmitter or receiver, as described herein, in another exemplary embodiment shown in FIGS. 56 and 57, a vehicle 370 can include a flexible light pipe 372 that extends from a first or left side 374 of vehicle 370 to a second or right side 376 of vehicle 370. As can be seen in FIG. 56, light pipe 372 is initially positioned so that each end 378 of flexible light pipe 372 is longitudinally offset toward a front 380 of vehicle 370. Occupancy space 12 includes a fixed transmitter 386 on one side of vehicle 370 and a fixed receiver 388 on a second, opposite side of vehicle 370, as shown in FIG. 57. When left end 378 aligns with fixed transmitter 386 and right end 378 aligns with fixed receiver 388, light transmitted by fixed transmitter 386 travels through light pipe 372 and enters fixed receiver 388. Receiver 388 transmits a signal to structure processor 16 indicating alignment of vehicle 370. Structure process 16 transmits a signal to vehicle 370 by way of, for example, structure communications 24 to vehicle communications 36, indicating alignment of vehicle 370 with occupancy space 12, and more specifically, with fixed transmitter 386 and fixed receiver 388. As vehicle 370 continues to move forward, vehicle 370 moves flexible ends 378 rearwardly to maintain alignment with fixed transmitter 386 and fixed receiver 388, as can be seen in FIGS. 56 and 57 until vehicle 370 reaches the park position.

Once the alignment process is complete during movement of vehicle 14, vehicle seats 66 stop moving forward with vehicle 14 to maintain seats 66 in a fixed location or position with respect to the docking structure platform 214. Such fixed relationship is because, in an exemplary embodiment, driver seat 66 is fixed to vehicle sensor 90, and vehicle sensor 90 moves with driver seat 66. In other words, as vehicle 14 moves forward, as described further hereinbelow, vehicle 14 moves with respect to seats 66 as vehicle 14 moves forward.

It should be understood that vehicle 14 can move relatively slowly during alignment of vehicle sensor 90 with sensor 91, which function as sensors to maintain alignment. Such relationship can be, for example, a magnet and magnetic sensor, an optical sensor and receiver, a sonic sensor, or other sensor configured to determine the proximity of a features, also called a proximity sensor. Such movement velocity can be in the ranges described elsewhere herein. In another embodiment, vehicle 14 can achieve an alignment of vehicle sensor 90 with structure sensor 91 by stopping vehicle 14 at the moment of alignment. In yet another embodiment, vehicle 14 can stop and perform a fine alignment of vehicle sensor 90 with structure sensor 91 if vehicle sensor 90 is movable. If vehicle sensor 90 is fixed, in a still further embodiment the motion of vehicle 14 can be slowed to a creep to refine the alignment of vehicle sensor 90 to structure sensor 91 to obtain alignment precision of plus or minus 0 mm to 5 mm of horizontal alignment deviation in the longitudinal direction between vehicle sensor 90 and structure sensor 91. As described elsewhere herein, vertical alignment can also be obtained between vehicle sensor 90 and structure sensor 91 by control of conventional vehicle systems, such as known vehicle adjustment and height control systems, to raise and lower the height of vehicle 14 or, alternatively, the height of structure platform 214 can be modified by raising and lower platform 214 and, accordingly, structure sensor 91, to precisely align vehicle sensor 90 and structure sensor 91. Such vertical alignment can be, for example, in a range from 0 mm to ±5 mm. In a further embodiment, such alignment can be, for example in a range from 0 mm to ±3 mm. In a still further embodiment, such alignment can be in a range from 0 mm to ±1 mm. After sensors are aligned to occupancy space 12, control passes from transition support alignment process 134 to a seat movement process 136a.

Seat movement process 136a begins configuring vehicle 14 for ease of egress and/or ingress by occupants of vehicle 14 as well as preparing to integrate vehicle 14 with occupancy space 12 during movement from the seat alignment position, which is also the first position, to the parked position, which is also the second position, where vehicle 14 will be anchored to occupancy space 12.

During seat movement process 136a, and subsequent processes steering wheel retraction process 136b and headrest movement process 136c, vehicle 14 continues to move a predetermined distance forward into dock space 64. In an exemplary embodiment, that distance is approximately six inches or 150 mm forward into dock space 64 from the seat alignment position. It should be noted that the time to move approximately 6 inches or 150 mm is one embodiment that provides time to expand the longitudinal spaced distance between seat 66 and dash 70 and the spaced distance between seat 66 and steering wheel 68 for ingress or egress of the driver and/or a passenger by opening up the space longitudinally in front of seat 66 in interior 226 of vehicle 14. Once door 72 is opened, the increased space between seat 66 and dash 70 is opened to occupancy space 12. In another exemplary embodiment, the distance could be approximately 4 inches or 100 millimeters. In a further exemplary embodiment, the distance could be approximately 8 inches or 200 millimeters. In a still further embodiment, the amount of movement may be adjustable, including in a range of 4 inches to 8 inches or 100 millimeters to 200 millimeters, or any range within the range of 4 inches to 8 inches or the range of 100 millimeters to 200 millimeters.

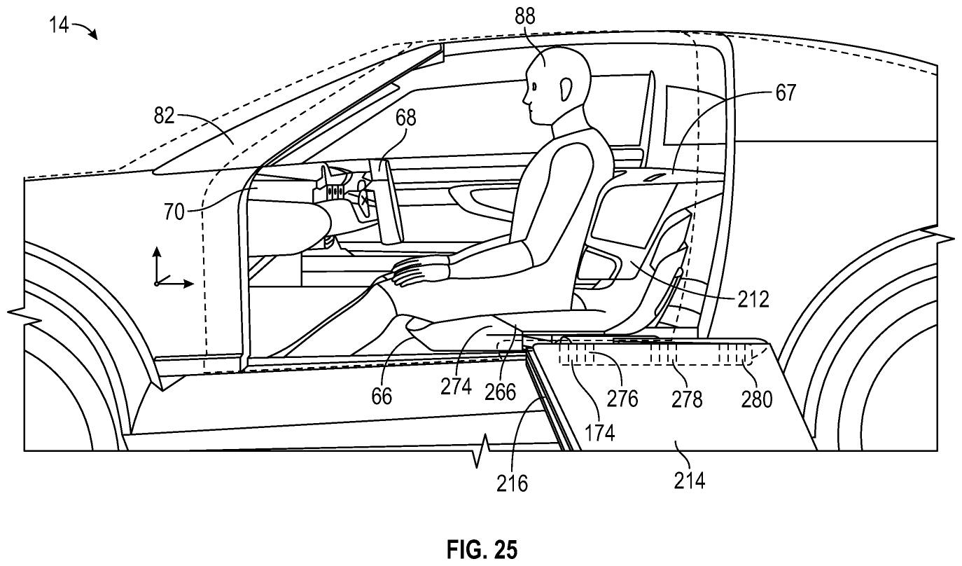

Two embodiments of aligning the top surfaces are disclosed. In one embodiment, shown in, for example, FIGS. 25 and 41-52, vehicle sensor 90 remains in a fixed relationship with structure sensor 91 as vehicle 14 moves forward. In other words, as vehicle 14 moves forward, vehicle sensor 90 moves to remain in a fixed position relative to structure sensor 91. In another embodiment, shown in, for example, FIG. 19, vehicle sensor 90 can be fixed to vehicle 14 and vehicle 14 can include a second sensor 93 that functions as a second aligner to align with structure sensor 91 to indicate when vehicle 14 is at the park position. Accordingly, in the embodiment with first vehicle sensor 90 and second vehicle sensor 93, first vehicle sensor 90 and second vehicle sensor 93 are fixed to vehicle 14 and do not move with respect to vehicle 14 as compared to the embodiment of FIGS. 25 and 41-52, whereas vehicle sensor 90 moves with respect to vehicle 14.

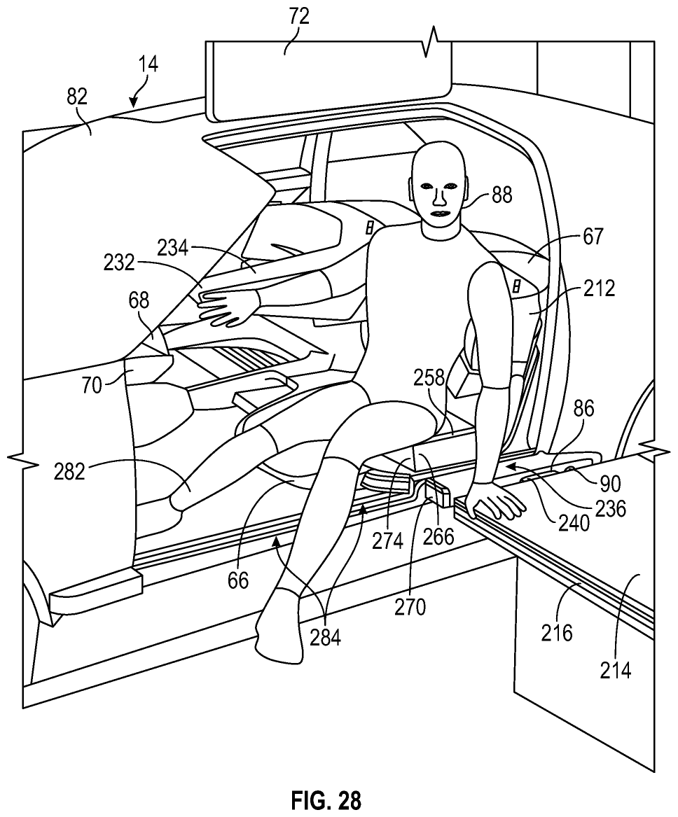

In both the described embodiments, where first vehicle sensor 90 moves relative to vehicle 14 and the embodiment where first sensor is fixed with respect to vehicle 14, front face 274 of movable transition support 266 remains in a fixed relationship relative to front face 272 of platform 214 while vehicle 14 moves forward to the park position. Once vehicle 14 reaches the park position, front face 274 of movable transition support 266 and/or intersection 273 of movable transition support 266 described elsewhere herein is approximately aligned longitudinally with front face 268 of internal transition support 256 when vehicle 14 is viewed in a plan view, as seen in, for example, FIG. 29. Referring also to FIGS. 28, one advantage to this alignment includes that movable transition support 266, which in an exemplary embodiment includes little or no structural support, is structurally fully supported by internal transition support 256. Another advantage to this alignment is that a clearance region 284 is formed in front of front face 274 of movable transition support 266, front face 268 of internal transition support 256, and front face 270 of external transition support 257 to provide an area for a driver 88 to swing driver's legs 282 from interior 226 of vehicle 14 to exterior 502 of vehicle 14. The passenger side of vehicle 14 can also be configured with a similar clearance area for the passenger to swings the passenger's legs from interior 226 of vehicle 14 to exterior 502 of vehicle 14.

The movement of vehicle 14 is under control of vehicle processor 28, which controls acceleration and braking that would normally be controlled by accelerator pedal 48 and brake pedal 46 of vehicle 14. The measurement of the distance traveled by vehicle 14 is accomplished by one or more sensors, including structure sensors 18, vehicle sensors 30, and/or the sensors that measure the rotation of one or more tires and wheels 96.

Since vehicle seats 66 and movable transition support 266 remain fixed with respect to docking platform 214 as vehicle 14 moves forward, vehicle processor 28 drives seat motors 32d to move seats 66 backward within vehicle 14 with respect a fixed location in occupancy space 12, such as docking structure 74. Accordingly, seats 66 remain stationary with respect to occupancy space 12 and dock space 64 as vehicle 14 moves forward. As indicated hereinabove, seats 66 remain fixed to a specific location on, for example, docking structure 74 during the forward opening movement of vehicle 14 and thus seats 66 move relative to the vehicle.

Once seat movement process 136a is initiated, control passes from seat movement process 136a to a steering wheel retraction process 136b. Vehicle processor 28 also drives steering wheel motor 32c to move steering wheel 68 forward within vehicle 14, thus retracting steering wheel 68 toward and into a predetermined location in, or flush with, vehicle dash 70. In an exemplary embodiment, movement of steering wheel 68 toward vehicle dash 70 can be proportional to the movement of vehicle 14 as vehicle 14 travels approximately six inches or 150 mm from the seat alignment position, or other travel distance described herein. In another exemplary embodiment, movement of the steering wheel is unrelated to the speed of travel of vehicle 14 as it moves from the seat alignment position. In an exemplary embodiment, steering wheel 68 can be retracted a distance of approximately 8 inches or 200 millimeters at a rate that is proportional to the movement of vehicle seats 66 and the forward motion of vehicle 14 over the distance between the first position and the second position. In another exemplary embodiment, retraction of steering wheel 68 is at a speed that is independent of the speed of vehicle 14 and/or the movement of seats 66. In yet another exemplary embodiment, steering wheel 68 can be retracted during approach to structure 74 since processor 28 controls operation of vehicle 14 in an exemplary embodiment and driver 88 no longer needs to operate steering wheel 68. In still another exemplary embodiment, steering wheel 68 can be retracted during movement within dock space 64 toward the seat alignment position. In still yet another exemplary embodiment, steering wheel 68 can be retracted into vehicle dash 70 as vehicle 14 moves from the seat alignment position to the park position. In a further yet exemplary embodiment steering wheel 68 can be retracted after vehicle 14 reaches the park position, which is also the anchor position. Once retraction of steering wheel 68 into dash 70 is initiated, control passes from steering wheel retraction process 136b to a headrest movement process 136c.

In headrest movement process 136c, headrest motor 32a is operated by processor 28 to move headrest 67 from a position atop or on top of seat 66 to a position behind an upper back portion of seat 66 to provide more room for driver 88 to see around him and to have additional space around seat 66.

It should be understood that while seat movement process 136a, steering wheel retraction process 136b, and headrest movement process 136c are described sequentially, in a preferred embodiment all three processes can occur simultaneously or nearly simultaneously in an overlapping manner or relationship. Further, since software commands operate sequentially, outputs to each of headrest motor or motors 32a, seat motor or motors 32b, and steering wheel motor or motors 32c may occur in sequence, but the motors may appear to be operating simultaneously since commands are transmitted as fast as processor 28 can transmit such commands. In an embodiment, movement of seat 66, retraction of steering wheel 68, and movement of headrest 67 can substantially overlap or be in an overlapping relationship such that start and stop of movement of each of seat 66, steering wheel 68, and headrest 67 appear to start and stop simultaneously. In another embodiment, a portion of the movement may be in an overlapping relationship, but start and stop times of each of seat 66, steering wheel 68, and headrest 67 may begin and end at slightly different times. In a further embodiment, start and stop times can be independent of each other. In a preferred embodiment, the start and stop of movement of each of headrest motor or motors 32a, seat or seat motors 32b, and steering wheel motor or motors 32, and, accordingly, seat 66, headrest 67, and steering wheel 98 occurs at about the same time so that movement appears to be simultaneous. It is further preferred that movement of seat 66, headrest 67, and steering wheel 98 is fully automatic, controlled by vehicle processor 68. However, movement of each of seat 66, headrest 67, and steering wheel 98 can be controlled manually and independently of each other.

Once headrest movement process 136c is initiated, control passes from headrest movement process 136c to a park position decision process 138.

In park position decision process 138, structure processor 16 and/or vehicle processor 28 determine whether vehicle 14 has reached the park position, which can be described as an anchor position or point since the parked position is where vehicle 14 is engaged to docking structure 74 by the anchor. If vehicle 14 has not reached the park position, control passes to a continue vehicle movement process 139, or further moving vehicle 14 in the moving direction relative to docking structure platform 214 and movable transition support 266 after movable transition support 266 is aligned with docking structure platform 214, where movement of vehicle 14 continues. Control then returns to seat movement process 136a, and processes 136a-136c are continued as appropriate.

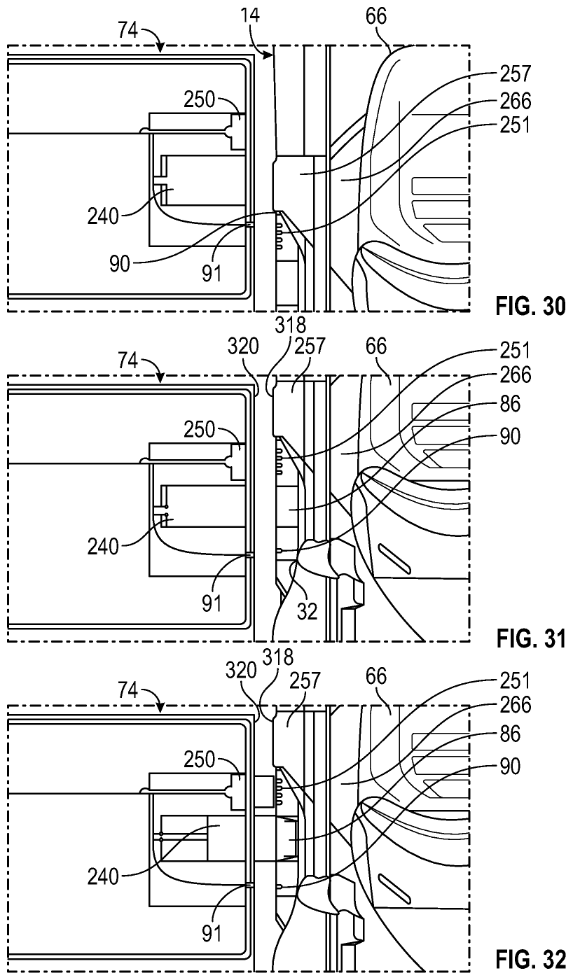

The park position is determined by alignment of transitions support 236 with docking platform 214, at which point the anchor on vehicle 14 should be aligned with the anchor of occupancy space 12. For example, anchor receptacle 86 of vehicle 14 is positioned to align with a mechanical anchor, such as anchor 224 shown in FIGS. 19 and 20, or anchor 240 shown in FIGS. 30-32, positioned in occupancy space 12. This alignment is performed by sensors, such as sensors 90 and 91 described herein, positioned in or on at least one of vehicle 14 and occupancy space 12. Signals are transmitted from the sensor(s) to structure process 16 indicating alignment of anchor receptacle 86 of vehicle 14, which is described in more detail herein, with the anchor of occupancy space 12.

It should be understood that anchor receptacle 86 can be at a plurality of locations along the longitudinal extent of vehicle 14 or vehicle body 500. Such locations can preferably include being near a center of gravity of vehicle 14 to help stabilize the position of transition support 236 and seat 66 with respect to docking structure 74 and to minimize movement of the vehicle. In addition, the central position of the vehicle anchor 86 provides a three-point stability since vehicle anchor 86 preferably engages only one side of vehicle 14. Accordingly, the weight of vehicle 14 is distributed over two tires on an opposite side of vehicle 14 from vehicle anchor 86 and partially into vehicle anchor 86 since vehicle anchor 86 is in a wedge configuration that provides some lifting of vehicle 14 when vehicle anchor 86 is engaged to docking structure 74. In an embodiment, the position of vehicle anchor 86 is longitudinally between tires and wheels 96 of vehicle 14, including being directly below or underneath transition support 236 in an overlapping relationship along the longitudinal extent of vehicle 14. Further, in a preferred embodiment, anchor receptacle 86 is below upper or upwardly facing surface 237 of transition support 236. More specifically, in an exemplary embodiment anchor receptacle 86 is below any upper surface of transition support 236. See anchor height 292 shown in FIGS. 36-38. Anchor height 292 is approximately a vertical centerline of anchor 240. Part of the reason for placing anchor receptacle 86 below transition support 236 as shown is because anchor receptacle 86 can be directly attached to a frame of vehicle body 500 for strength, and positioning anchor receptacle 86 below transition support 236 makes such direct connection easier because the vehicle frame extends below vehicle interior 226. The height of anchor receptacle 86 can be measured from the ground level and can be described as the anchor height. As should be apparent from the description herein, the anchor height is lower or less than the support height of transition support 236. In an exemplary embodiment, vehicle anchor receptacle 86 overlaps or is in an overlapping relationship with transition support 236 in a longitudinal direction when viewed in a direction that is transverse to the longitudinal direction of vehicle 14. Further, when vehicle 14 is viewed in a plan view, in an exemplary embodiment transition support 236 overlaps vehicle anchor 86 since vehicle anchor 86 can be directly below or underneath transition support 236.

Once vehicle 14 has reached the park position, control passes from park position decision process 138 to a stop movement process 140.

In stop movement process 140, vehicle processor 28 actuates vehicle brake, which may include movement of brake pedal 46, stopping vehicle 14. Vehicle processor 28 then shifts a transmission of vehicle 14 (not shown) into park, and vehicle processor 28 may then operate ignition/power 50 to stop operation of an engine of vehicle 14 (not shown). In addition, movement of each of headrest motor or motors 32a, seat motor or motors 32b, and steering wheel motor or motors 32c is stopped if such movement is proportional to the movement of vehicle 14. If movement of each of headrest motor or motors 32a, seat motor or motors 32b, and steering wheel motor or motors 32c is based on some other criteria, such as time, movement of each motor is terminated in stop movement process 140. Once stop movement process 140 is complete, vehicle 14 is in a parked position and control passes to an anchor process 142.

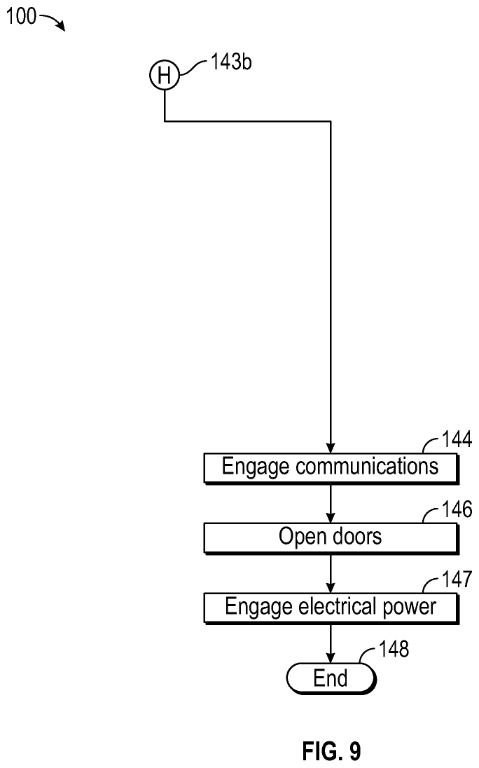

During anchor process 142, vehicle 14 is securely engaged by the vehicle anchor and the structure, such as anchor 224 or 240 attached to occupancy space 12; e.g., see FIG. 20, which can move to engage with anchor receptacle 86 positioned on vehicle 14. The anchor and receptacle may engage such that the engagement of the anchor, which can be tapered as shown in FIGS. 30-32, with anchor receptacle 86 exerts an upward force on vehicle 14 and lifts vehicle 14 by a predetermined amount, such as 1 mm to 25 mm, thus releasing a portion of load on the shock absorbers (not shown) of vehicle 14. The vehicle anchor is positioned at a location between front vehicle wheel 96 and back vehicle wheel 96 to restrict or minimize movement of parked and anchored vehicle 14. Once the anchor is engaged with vehicle 14, ignition 50 of vehicle 14 is disabled and a transmission of vehicle 14 is disabled to secure vehicle 14 and to reduce the risk that vehicle 14 will move. Accordingly, vehicle 14 is securely engaged with the structure of dock space 64. Once anchor process 142 is complete, control passes from anchor process 142 to off-page connector 143a to on-page connector 143b in FIG. 9 to an engage communications process 144.

In engage communications process 144, vehicle processor 28 and structure processor 16 cooperate to establish communications between vehicle communications 36 and structure communications 24. In an embodiment, communications between vehicle communications 36 and structure communications 24 can be wirelessly. In another embodiment, communications between vehicle communications 36 and structure communications 24 can be by a wired connection. Once communications are established between vehicle 14 and occupancy space 12, control passes from engage communications process 144 to an open door process 146.

In open door process 146, processor 28 operates door motors 32d to open one or both vehicle doors 72. It should be noted that in a preferable embodiment doors 72 are only opened after vehicle 14 stops at the second position. Further, in a more preferable embodiment, opening of doors 72 occurs only after the vehicle 14 is anchored. Control then passes from door open process 144 to an engage electrical power process 147, where electrical power is connected between vehicle 14 and occupancy space 12. Such connection can be by a connector, such as a connector assembly 250 shown in FIGS. 30-32 that is extended by an actuator or a motor to interface with a vehicle connector 251. In an alternative embodiment, electrical power can be connected between vehicle 14 and occupancy space 12 by an electrical connector integral with the vehicle anchor, as described herein. In yet another embodiment, electrical power can be connected between vehicle 14 and occupancy space 12 by an electrical connector formed in one or both vehicle doors 72, which engages with a mating connector positioned in occupancy space 12 to provide power to vehicle 14. Upon completion of engagement of power between the door connector to the mating connector of occupancy space 12, control passes from engage electrical power process 147 to an end process 148, where system process 100 ends.

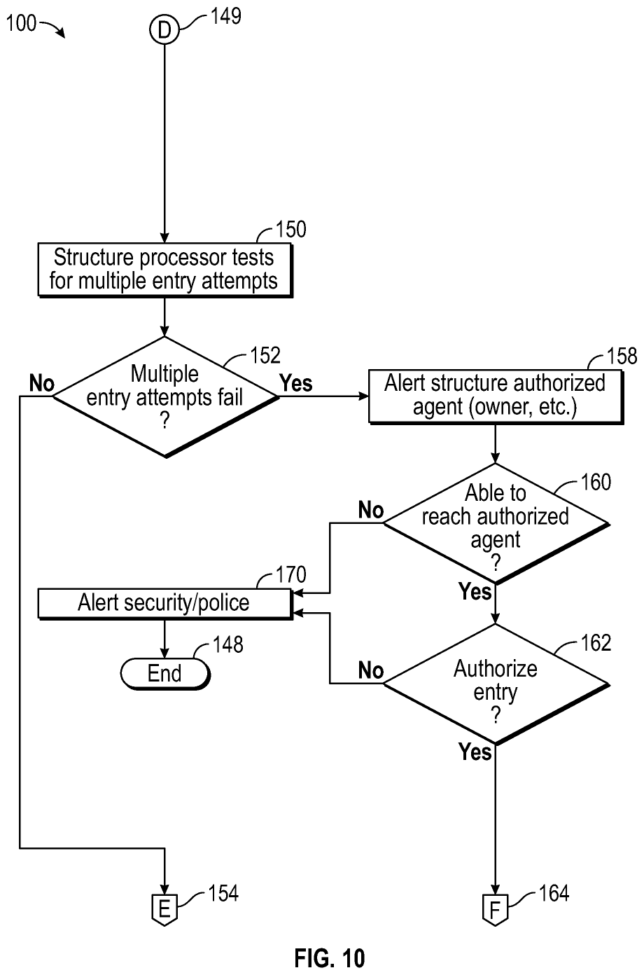

Returning to entry authorized decision process 116 in FIG. 7, if the identification information provided by vehicle processor 28 does not match predetermined acceptable identification information stored in non-transitory memory connected to structure processor 16, control passes from entry authorized decision process 116 to a multiple entry attempts process 150 by way of an off-page connector 118 to an on-page connector 149 in FIG. 10.

In multiple entry attempts process 150, structure processor 16 determines how many attempts were made by vehicle 14 to gain access to occupancy space 12. Control then passes from multiple entry attempts process 150 to an entry fail decision process 152. If the number of failed entry attempts is below a predetermined number, such as five attempts in an exemplary embodiment, control returns to identification request process 106 by way of off-page connector 154 to an on-page connector 156 in FIG. 7, which functions as described hereinabove. On the other hand, if the number of failed entry attempts is greater than the predetermined number of attempts, then the test for excessive entry attempts is a positive and control passes from entry fail process 152 to an alert process 158.

In alert process 158, structure processor 16 attempts to reach an authorized agent by communications 24, which can include a landline and/or cellular communication device. Control then passes from alert process 158 to an authorized agent decision process 160, where structure processor 16 determines whether an authorized agent has been contacted. An authorized agent can be, for example, the homeowner or an agent of a monitored security service. If an authorized agent was not reached, control passes from authorized agent decision process 160 an alert security or police process 170, in which structure processor 16 contacts security services and/or police to inform them of an attempt to gain access to occupancy space 12 by an unauthorized vehicle 14. After notification of security or police, control passes from alert security or police process 170 to end process 148 that, as described hereinabove, ends system process 100.

Returning to authorized agent decision process 160, if an authorized agent was reached, control passes from authorized agent decision process 160 to an authorize entry decision process 162. If the authorized agent granted access to occupancy space 12 by vehicle 14, control passes from the authorize entry decision process 162 to open entry door process 120 by way of off-page connector 164 to on-page connector 168 in FIG. 7. Open entry door process 120 then functions as described hereinabove. Alternatively, if the authorized agent did not grant access to occupancy space 12 by vehicle 14, then control passes to alert security or police process 170, which functions as described hereinabove.

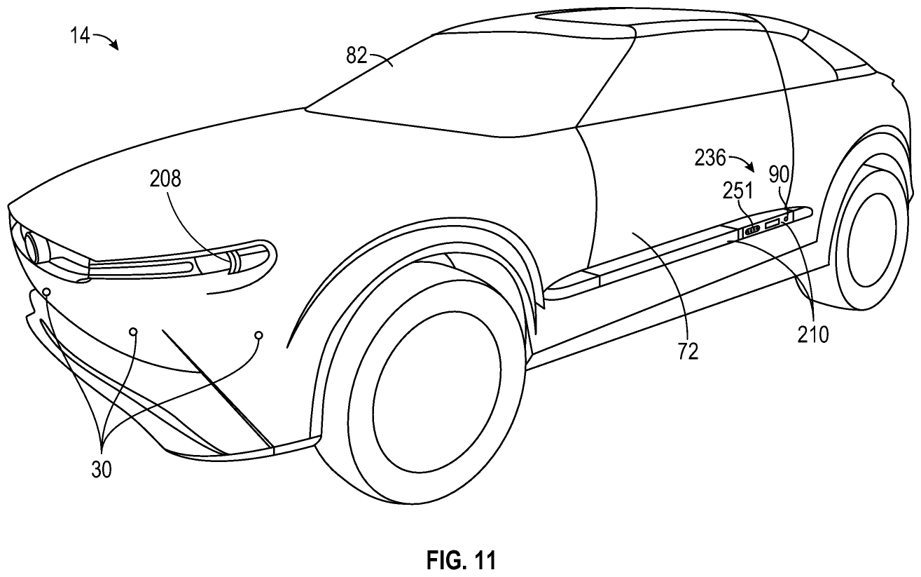

Embodiments of vehicle 14 and occupancy space 12 used in the vehicle integrations processes described hereinabove are presented in FIGS. 11-57.

FIG. 11 shows a perspective view of vehicle 14 in accordance with an exemplary embodiment of the present disclosure. Vehicle 14 includes vehicle sensors 30, as described hereinabove, which can include more or less sensors shown in FIG. 11. Sensors 30 are active when vehicle 14 enters occupancy space 12, though sensors 30 can be active as vehicle 14 approaches docking structure 74 while in a driving mode, such as is shown in FIG. 21. Vehicle 14 includes headlights 208 and vehicle side lights 210. During dock entry process 128, an intensity of headlights 208 can be reduced at a beginning of dock entry process 128, or when vehicle 14 is at a predetermined location in occupancy space 12. In addition, vehicle side lights 210 are activated during dock entry process 128. Such lights can provide an indication to occupants of occupancy space 12 that vehicle 14 is in dock entry process 128, and a glow from vehicle side lights 210 can be sufficiently intense that the driver and/or the passenger are able to see a visual indication of docking position. As vehicle 14 approaches the seat alignment position, vehicle side lights 210 can provide an indication, such as increasing intensity, change color, such as change from a reddish or orange color to a less red or yellow color and then to a blue color or green color to indicate vehicle 14 is at the seat alignment position. Vehicle side lights 210 can further indicate movement from the seat alignment position to the park position by changing from a constant intensity to flashing, with flashing speed increasing until vehicle 14 is positioned at the parked position, at which time vehicle side lights 210 can return to a constant, non-flashing intensity. Vehicle side lights 210 are located on both sides, i.e., left side 374 and right side 376 of vehicle 14; see at least FIGS. 56 and 57 for left side 374 and right side 376.

FIGS. 12 and 13 shows plan views of occupancy space 12 of FIG. 11. A zone of approach 58 is outlined in dashed lines. Zone of approach 58 is a region in which vehicle 14 is able to establish communication with structure processor 16 to accomplish auto-docking. Outside of zone of approach 58, vehicle 14 may be unable to complete auto-docking until vehicle 14 is within a distance where structure sensors 18 are able to provide guidance to vehicle 14. However, vehicle 14 may include autonomous driving capability that is independent of structure processor 16 and structure sensors 18, and that autonomous driving capability may be configured to position vehicle 14 within zone of approach 58 by use of conventional systems such as a GNSS system, GPS system, dead reckoning system, map system, and like, in conjunction with vehicle sensors that position vehicle 14 on a road and guide vehicle 14 to various locations. It should be understood that zone of approach 58 should not be limited to the configuration shown in FIG. 12. For example, zone of approach 58 can be a relatively long driveway that has been mapped to structure processor 16. Alternatively, multiple external sensors (not shown) may be positioned along an entry driveway 60 to enable vehicle 14 to access a relatively long distance, such as dozens of feet or meters, to hundreds of feet or meters, along a driveway from an entrance 62 to reach door or doors 52.

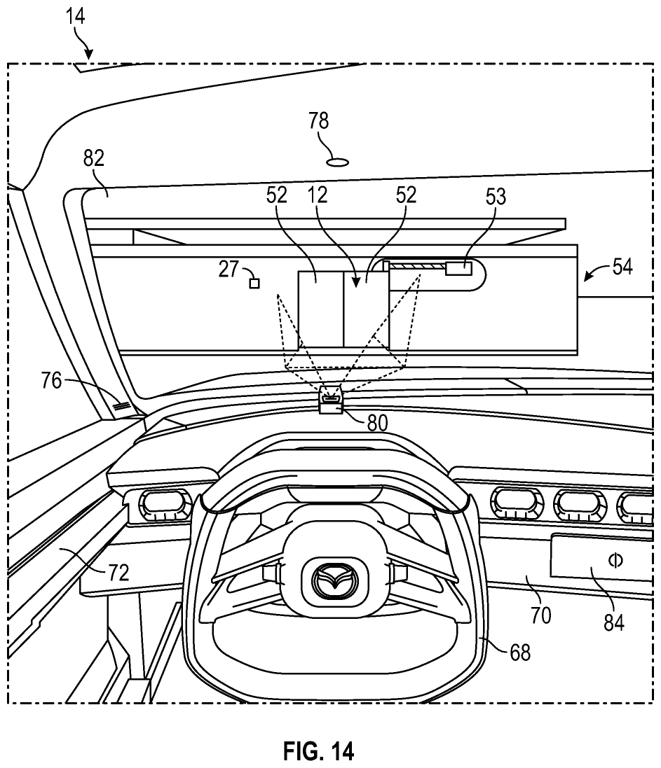

FIG. 14 shows an external elevation view of an exterior 54 of occupancy space 12 of FIG. 3 as seen from interior 226 of the vehicle of FIG. 11 in accordance with an exemplary embodiment of the present disclosure. As noted hereinabove, occupancy space 12 includes wireless second communications device 27 that is configured to communicate with at least a transmitter in vehicle 14. It should be understood that communications device 27 can be internal to occupancy space 12. Occupancy space 12 also includes at least one external door 52 configured to open and close to permit physical access or communication between exterior 54 of occupancy space 12 and an interior 56 of occupancy space 12. Preferably, external door or doors 52 are opened and closed, i.e., controlled, by structure processor 16. However, in other exemplary embodiments, vehicle processor 28 can be configured to control motor or drive 20 that opens and closes door or doors 52. In still another exemplary embodiment, door 52 or doors 52 can be opened manually. While not shown, it should be understood that door or doors 52 can include a sensor to detect when door or doors 52 are fully open to permit auto-docking of vehicle 14. In other words, vehicle 14 is not permitted to auto-dock until door or doors 52 are opened to permit vehicle 14 to access interior 56 of occupancy space 12.

As vehicle 14 approaches a structure 74 in which occupancy space 12 is located, various vehicle systems can be actuated to communicate with the driver of vehicle 14 as well as receiving input from the driver of vehicle 14. For example, vehicle 14 can include audio speaker 76 for issuing audio alerts, such as indicating that approach zone 58 has been reached or requesting permission to actuate auto-dock. Vehicle 14 can also include microphone 78 positioned in vehicle interior 226 of vehicle body 500 to receive voice commands from the driver or passenger of vehicle 14. Such voice commands can be, for example, “engage auto-dock.” Vehicle 14 may also include a heads-up display or HUD 80 that displays information on an interior of front screen or windshield 82 of vehicle 14 that shows status of docking with occupancy space 12, including alignment information, reaching the seat alignment position, reaching the transition support alignment position, and/or reaching the park position, vehicle speed, park status, and the like. Vehicle 14 can also include input buttons and/or display/input screen 84 that the driver or passenger can use to engage auto-dock and/or other vehicle 14 functions.

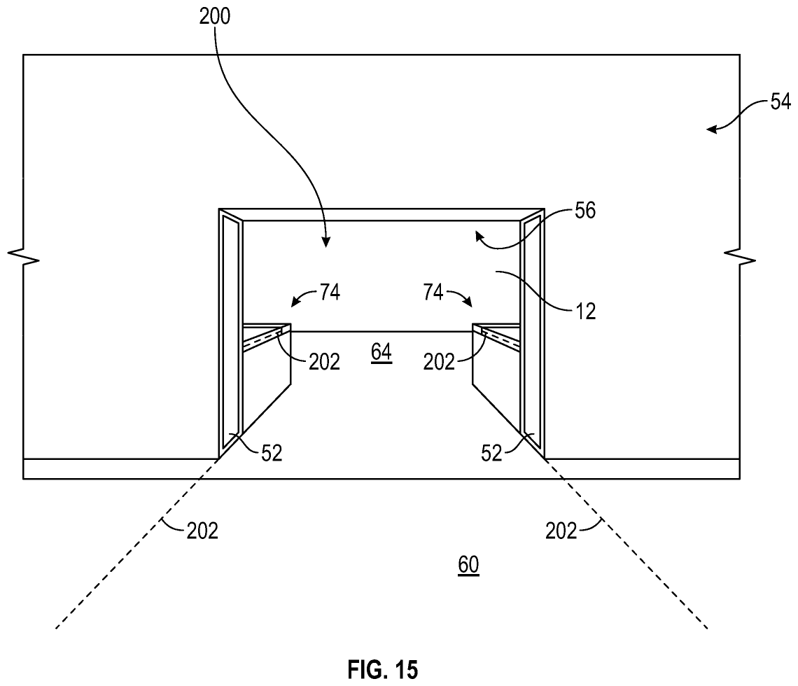

FIG. 15 shows a view of an entryway 200 into occupancy space 12 of FIG. 12 in accordance with an exemplary embodiment of the present disclosure, with doors 52 retracted. Entryway 200 can include a plurality of lights 202 to provide a visual indication that auto-docking has begun. Lights 202 can extend along driveway 60, or be positioned partially within occupancy space 12. Lights 202 can change visual indication to indicate alignment issues, such as color, brightness, or flashing, to indicate correct alignment with a vehicle port or dock space 64, and/or to provide other indications to the driver regarding status of vehicle 14 approach to dock space 64 of occupancy space 12.

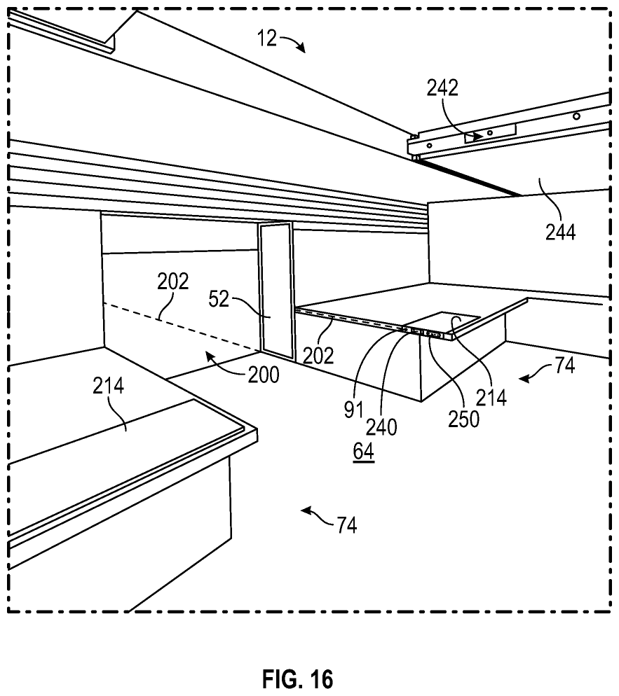

FIG. 16 shows a perspective view of the interior of occupancy space 12 of FIG. 12 looking toward entryway 200 in accordance with an exemplary embodiment of the present disclosure. Structure alignment sensor 91 can be seen in FIG. 16, as well as anchor 240, which can also be described as docking anchor 240, that can be positioned as part of platform 214, and a ceiling connector 242 that engages with a comparable detector in a gull wing door 72. Ceiling connector 242 is properly aligned with a similar detector in gull wing door 72 only when vehicle 14 is at the parked position. Ceiling connector 242 can include a power connector as well as a data connector. In an exemplary embodiment, platform 214, anchor 240 positioned on platform 214, and any connectors for connecting data and/or power between vehicle 14 and structure 74 can be described as a docking structure.

FIG. 17 shows a view of vehicle 14 that has approached and is entering occupancy space 12 of FIG. 12 in accordance with an exemplary embodiment of the present disclosure. FIG. 17 also shows exemplary locations of various vehicle controls when seats 66 and steering wheel 68 are in a position of the driving mode of vehicle 14 in accordance with an exemplary embodiment of the present disclosure.

In FIG. 17, Vehicle 14 has already transmitted the proximity signal according to proximity signal transmitting process 102, and occupancy space 12 has already received the proximity signal in proximity signal receiving process 104. Further, structure identification request process 106, identification request received process 108, vehicle identification process 110, structure identification receipt process 112, identification analysis process 114, and entry authorized decision process 116 have all been completed, and doors 52 have been opened according to open entry door process 120. Further, auto-dock actuation process 122, auto-dock transmission process 123, and structure sensor actuation process 126 are all complete, and dock entry process 128 is in process.

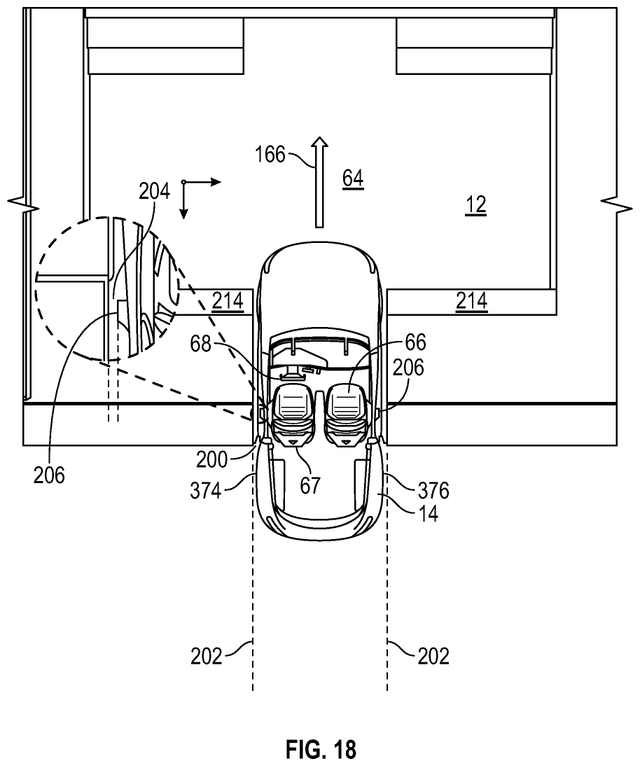

FIG. 18 shows a further view of vehicle 14 and occupancy space 12 of FIG. 17 as vehicle 14 continues to enter occupancy space 12 in accordance with an exemplary embodiment of the present disclosure. In FIG. 18, vehicle 14 continues to be under the control of vehicle processor 28 as vehicle 14 is driven or operated to proceed into dock space 64. Vehicle 14 is operated by vehicle processor 28 to maintain a clearance or spaced distance 204 with, for example, on each side of vehicle 14 with respect to entryway 200 as well as other features of docking space 64 and occupancy space 12. Clearance or spaced distance 204 can be considered a side clearance since clearance or spaced distance 204 is with respect to sides 206 of vehicle 14. In a preferred embodiment, clearance, or spaced distance 204 can be approximately 20 mm. However, in another preferred embodiment, clearance 204 can be in a range from 2 mm to 200 mm. In a further preferred embodiment, clearance 204 can be in a range from 2 mm to 100 mm. In a yet further preferred embodiment, clearance 204 can be in a range from 2 mm to 50 mm. In a still further preferred embodiment clearance 204 can be a in a range from 10 mm to 30 mm with a nominal clearance of 20 mm. It should be understood that all clearances or spaced distances are on both sides 206 of vehicle 14; i.e., left side 374 and right side 376.

FIG. 19 shows a vehicle approaching a transition support alignment position.

FIG. 20 shows a view of vehicle 14 at the parked position or location, which is also where vehicle 14 is anchored with respect to features of occupancy space 12 in accordance with an exemplary embodiment of the present disclosure. The parked position is defined by alignment of anchor receptacle 86 on vehicle 14 with a structure anchor, such as anchor 224 or 240 described elsewhere herein. At the parked position, processes 138-146, described hereinabove, are performed. In other words, vehicle 14 is integrated with occupancy space 12 by the structure anchor engaging anchor receptacle 86, by steering wheel 68, seats 66, and headrests 67 moving to open interior space 226 with respect to occupancy space 12. Opening interior space 226 is more than just opening vehicle doors 72, it is providing a larger egress/ingress area by the movement of steering wheel 68 to integrate with dash 70, and by moving seat 66 back, headrest 67 pivotally backward, and a seatback 212 backward and down, obstruction of a door opening 504 of vehicle 14 by interior components of vehicle 14, such as steering wheel 68, seats 66, headrests 67, and seatback 212, is significantly reduced, which enables an easier egress and ingress from and to vehicle 14.

FIG. 21 shows a view of the vehicle of FIG. 12 configured in a driving mode of operation in accordance with an exemplary embodiment of the present disclosure. In the driving mode, seats 66 are positioned so that driver 88 can easily access steering wheel 68 along with interior vehicle controls. Head rests 67 are in an upright position. FIG. 21 also shows an anchor receptacle 86, which receives a structure anchor of occupancy space 12, such as anchor 224 shown in FIGS. 30-32, also described in more detail herein.

FIG. 22 shows a driver's side view of vehicle 14 of FIG. 12 with driver's door 72 removed and with vehicle 14 in an approach mode in accordance with an exemplary embodiment of the present disclosure. Approach mode can exist after structure processor 16 has communicated to vehicle 14 that entry to occupancy space 12 is authorized, and prior to dock entry process 128. In another embodiment, approach mode may be part of dock entry process 128. During approach of vehicle 14 toward entryway 200, headrest 67 can remain upright, or headrest 67 can move from the upright position shown in, for example, FIG. 21, to the lowered position shown in FIG. 22. Seat 66 includes seat back 212 that can be lowered or angled backwardly toward a rear of vehicle 14 during the approach mode and/or during entry into dock space 64.

As described hereinabove, vehicle processor 28 is controlling vehicle 14 during approach and entry into dock space 64, and such control by vehicle processor 28 can be described as driver assist or driving assist since driver 88 can override certain functions of vehicle processor 28. For example, while vehicle processor 28 may not permit driver 88 to take control of steering wheel 68, driver actuation of brake pedal 46 can override control by vehicle processor 28.

FIGS. 23 and 24 show views of vehicle 14 and occupancy space 12 of FIG. 19, with vehicle 14 positioned at the seat alignment location with respect to features of occupancy space 12 in accordance with an exemplary embodiment of the present disclosure. Structure 74 includes sensor 91 located at a predetermined location in occupancy space 12, such as on docking structure 74. As vehicle 14 enters dock space 64, vehicle sensor 90 will align with structure alignment sensor 91 within several millimeters, or less. When alignment between vehicle sensor 90 and sensor 91 occurs, vehicle 14 is positioned at a location that is described herein as the seat alignment position or seat alignment location. As described hereinabove, only sensors 90 may be used to align vehicle 14 with docking structure 74. For example, sensors 90 can include cameras with visual recognition capability that can entirely positioned transition support 236 in alignment with docking structure platform 214.

As noted hereinabove, occupancy space 12 includes platform 214. Platform 214 can include platform lights 216. Platform 214 is positioned at a height that is at approximately a same support height 290 of transition support 236, which can be support height 290 of internal transition support 256 and/or external transition support 257, as shown in FIGS. 36-38. It should be noted in FIGS. 36-38 that a seating height 288 of user 88 is a height above floor 94 of docking space 64 at which user 88 is supported. An upper surface of transition support 236 includes a support height 290 that at transition support 236 is approximately the same height at support height 294 of the upper surface of docking structure platform 214. Anchor height 292 is below support height 290 and below platform support height 294. Seating height 288 is equal to or shorter than or less than support height 290 and platform support height 294. Conversely, the support height is at or above the seating height.

In an exemplary embodiment, platform 214 is positioned at approximately the support height of transition support 236. This vertical position means that when vehicle 14 comes to a complete stop in dock space 64, transition support 236 is at approximately the same height as platform 214, such that driver 88, and any passenger, are able to easily slide or move from a respective vehicle seat 66 to a respective left or right structure platform 214. It should be understood that the height of platform 214 can be adjustable to be set to the support height of vehicle 14. In another embodiment, vehicle seat 66 can be programmed to be controlled by vehicle processor 28 to raise or lower vertically to be at the support height of structure platform 214 or is otherwise adjusted manually to be at the support height of structure platform 214. In still another embodiment, a suspension system including shock absorbers (not shown) of vehicle 14 can be adjusted to match the support height of transition support 236 and/or seats 66 with the support height of structure platform 214. Such movement includes positioning the upper or top surface of external transition support 257, which extends generally horizontally, in a vertical direction by one or more adjustment apparatuses, such as vehicle 14 shock absorbers or suspension, or a vertical adjuster to position the upper surface of external transition support 257 to be aligned with an upper surface of platform 214 to align support heights. In another exemplary embodiment, the support height of external transition support 257 is aligned in the vertical direction to be at a same support height of the docking support platform 214. Accordingly, transition support 236, and particularly external transition support 257, can be horizontally and vertically aligned with platform 214.

As described hereinabove, the orientation of vehicle 14 sets a spaced distance between exterior face or surface 271 of transition support 236 and docking platform 214. However, due to transverse misalignment or for other reasons, the spaced distance may be further than is desirable by the user. Accordingly, docking platform may be transversely movable to extend transversely toward transitions support 236. In a further preferred embodiment, once vehicle 14 is at the parked position, docking platform 214 can move to extend to a location that is in interior space 226 of vehicle 14, including to movable transition support 266.

Platform lights 216 can be controlled to provide an indication that vehicle 14 is in alignment with platform 214, which, as described hereinabove, is when vehicle sensor 90 of vehicle 14 is aligned with structure alignment sensor 91. Each of vehicle sensor 90 and structure alignment sensor 91 can be a transmitter only, a receiver only, a combination of a transmitter and a receiver, or a transceiver, as long as at least one of vehicle sensor 90 and structure alignment receiver/transmitter 91 has at least one transmitter and at least one receiver, since one of vehicle sensor 90 and structure alignment sensor 91 can be a passive reflector or be a passive material detectable by a sensor. Also, as described herein, in a preferred embodiment vehicle sensor 90 can be a camera and alignment decisions are made on a basis of image analysis of features of docking structure 74. In another preferred embodiment, structure sensor 91 can be a camera and alignment decisions are made on a basis of image analysis of vehicle 14. Accordingly, in the context of this disclosure, a sensor used for vehicle sensor 90 and structure alignment sensor 91 can be a conventional sensor such as an optical transmitter and/or receiver, a radiofrequency transmitter and/or receiver, a magnetic sensor, a camera, or other sensor configured for alignment of a transmitter and a receiver within several millimeters of each other. It should be understood that vehicle sensor 90 can include, for example, a transmitter only, and fixed structure sensor 91 can include, for example, a receiver only, and vice versa.

FIG. 25 shows a further driver's side view similar to the view of FIG. 24 as vehicle 14 prepares to transition from the seat alignment position with respect to occupancy space 12 to the park position or location in occupancy space 12 in accordance with an exemplary embodiment of the present disclosure. In a preferred embodiment, the parked position becomes the anchored position. FIG. 25 shows an embodiment where sensor 174, which can be a conventional passive element such as a marker, magnet, or the like, or an active sensor similar to sensor 90, is movable as vehicle 14 moves from the seat alignment position to the park position. FIG. 25 shows a first position 276 of element 174, which occurs at the seat alignment position, a subsequent, intermediate position 278 of element 174, which occurs during the transition from the seat alignment position to the parked position, and a second position 280 of element 174 when vehicle 14 is at the parked position. The locations of positions 276, 278, and 280 are greatly exaggerated in FIG. 25 for clarity. Also see FIGS. 42-46, which shows a sliding door 172 that covers sensor 90, anchor receptacle 86, and connector 251. Sliding door 172 protects sensor 90, anchor receptacle 86, and connector 251 when vehicle 14 is in an environment where dirt, dust, mud, snow, ice, water, and other debris may be present. As vehicle 14 moves forward from the seat alignment position, transmitter/receiver 174 remains fixed with the alignment location in occupancy space 12 or with the alignment location on docking structure 74. Accordingly, transmitter/receiver 174 moves rearwardly with respect to vehicle 14 as vehicle 14 moves from the seat alignment position to the park position.

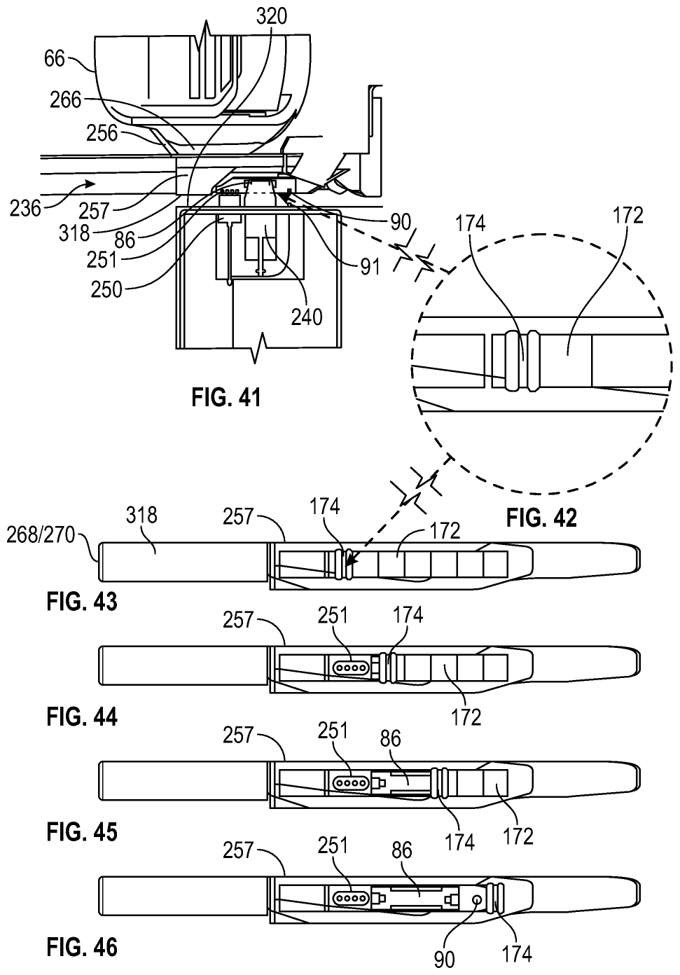

As vehicle 14 nears the park position, sensors 90 and 91 come into opposition, with a space, gap, or spaced distance between them, as shown in FIG. 41. As described herein, sensors 90 and 91 can be paired and can comprise at least one receiver and at least one transmitter. For example, sensor 91 can transmit a signal, such as an optical or ultrasonic signal, to sensor 90 to indicate alignment of vehicle 14 with docking structure 74 at the park position. Once alignment is achieved, an electrical power connection and anchoring of vehicle 14 to docking structure 74 occurs. As shown in FIG. 41, anchor 240 is driven into engagement with anchor receptacle 86 on vehicle 14. Anchor 240 can be in a wedge shape and anchor receptacle 86 can have a similar wedge shape, though offset lower than anchor 240 so that as anchor 240 is driven into anchor receptacle 86, such as by a ball screw linear actuator, hydraulic actuator, or other mechanisms, the upward force on anchor receptacle 86 lifts vehicle 14 upwardly, more firmly fixing vehicle 14 to docking structure 74. An actuator (not shown) can also drive connector assembly 250 toward vehicle connector 251. Connector assembly 250 and vehicle connector 251 can connect power between vehicle 14 and docking structure 74. Such power can be provided to vehicle 14 by docking structure 74, including structure power 26, which can be grid power 40. Conversely, power can be provided to docking structure 74 and occupancy space 12 by vehicle power 38, particularly when vehicle 14 is electrically powered.

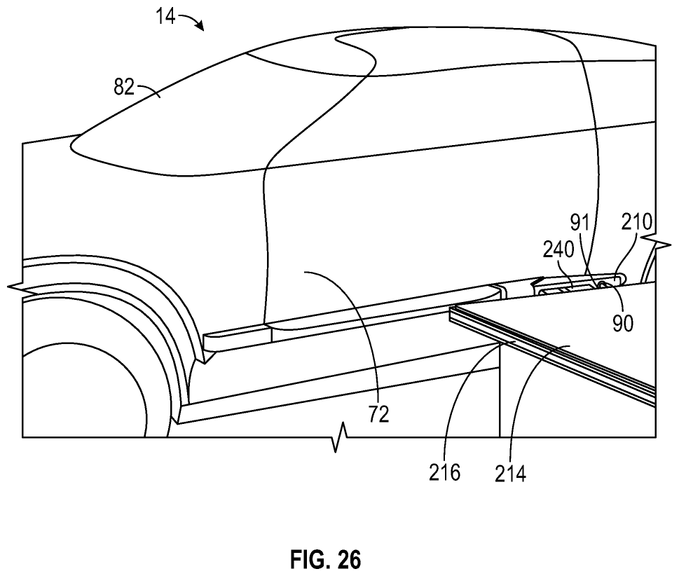

FIG. 26 shows a perspective view of vehicle 14 with vehicle 14 at the parked position with respect to structure platform 214. FIG. 34 shows a view of vehicle 14 that is similar to FIG. 26 prior to the extension of anchor 240 and connector assembly 250. Note that the gap shown in FIG. 34 is larger than the actual gap, which is preferably a few millimeters. The enlarged gap in FIG. 34 is for the sake of visibility of the features shown.

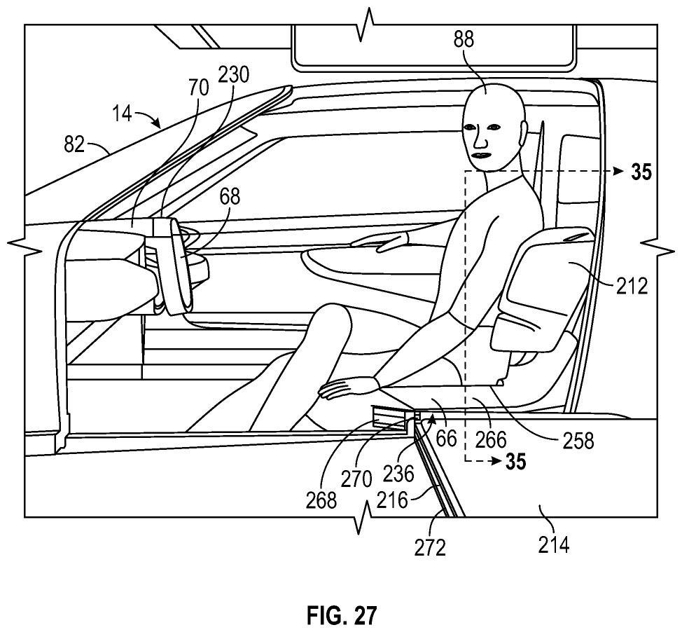

Referring to FIGS. 27-29, when vehicle 14 is at the parked position, at least one platform 214, since there can be left platform 214 and right platform 214, is aligned through seats 66, as indicated by an imaginary line 238 shown in FIG. 29. Alignment is when front edge 272 of structure platform 214 is approximately aligned with front edge 270 of external transition support 257. Line 238 of alignment provides an optimal transverse position of platform(s) 214 with seat(s) 66 to aid in egress and ingress from vehicle 14, which in an exemplary embodiment is at the support height described herein. In another exemplary embodiment, egress and ingress is at the support height of platform 214, which is also the support height of vehicle 14. In an exemplary embodiment, alignment between front edge 270 and front edge 272 can be 0 mm to ±5 mm. Alignment should be as close as possible for optimum transition between seat(s) 66 and structure platform 214. Accordingly, in another exemplary embodiment alignment between front edge 270 and front edge 272 can be 0 mm to ±2.5 mm. However, in some circumstances, alignment between front edge 270 and front edge 272 can be 0 mm up to ±25 mm or ±1 inch.

As can be see, for example, in FIGS. 27 and 29, steering wheel 68 is moved by retraction into dash 70 from an extended position as shown in, for example, FIG. 17, to be directly adjacent to dash 70, with edges 230 of steering wheel 68 in alignment with dash 70. Alignment in the context of this disclosure means a surface of edge 230 continues along approximately a same contour as an adjacent contour of dash 70 when steering wheel 68 is fully retracted.

FIG. 28 shows a perspective view of vehicle 14 in the anchored position prior to door 72 opening in accordance with an exemplary embodiment of the present disclosure. When vehicle 14 is in the park or anchored position, one or more lights, such as vehicle side lights 210 and platform lights 216, can provide a visual indication that vehicle 14 is in the anchor position. Lights 210 and lights 216 can illuminate with a particular color or color sequence, or can flash off and on in a predetermined pattern to indicate that the anchor position is reached. The indication of the anchor position may also be displayed on a display on dash 70 such as HUD 80. The indication that vehicle 14 is in the anchor position is in part a safety measure to remind driver 88 and any passenger as well as occupants of occupancy space 12 that elements of vehicle 12, such as vehicle door 72, and elements of occupancy space 12, such as anchor 224 or anchor 240, are about to move.

Also as shown in, for example, FIG. 28, vehicle interior 226 can also include a center arm rest 232 having a generally horizontally extending upper surface 234 that in an exemplary embodiment can be raised and lowered vertically without pivoting to provide variable vertical positions of upper surface 234. The advantage of such vertically moving center arm rest 232, which moves independently from seat 66, is that center arm rest 232 is more easily adjustable for various drivers and for improved integration of interior space 226 with occupancy space 12.

Referring to FIGS. 30-32, features of vehicle 14 and features of docking structure 74 can be seen when vehicle 14 is moving to the park position, which is shown in FIG. 30, when vehicle 14 is at the parked position, which is shown in FIG. 31, and when vehicle 14 is anchored to docking structure 74, which is shown in FIG. 32, where vehicle 14 is now simultaneously at the parked position and the anchored position. Indicating that vehicle 14 is at the parked position can be accomplished by, in an exemplary embodiment, aligning sensor 90 with a sensor, such as a sensor similar to sensor 91, at the seat alignment position, and then moving vehicle 14 a predetermined distance to the park position. Alternatively, vehicle 14 can include two sensors to identify the seat alignment position and the parked position with respect to a fixed sensor 91 on docking structure 74. In yet another embodiment, docking structure 74 can have two fixed sensors 91 and sensor 90 can be identified at two locations in docking structure 74.

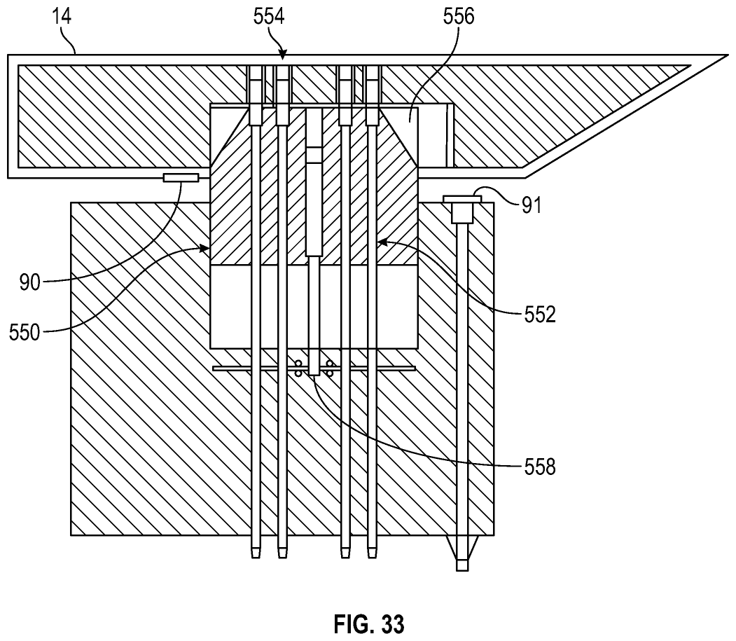

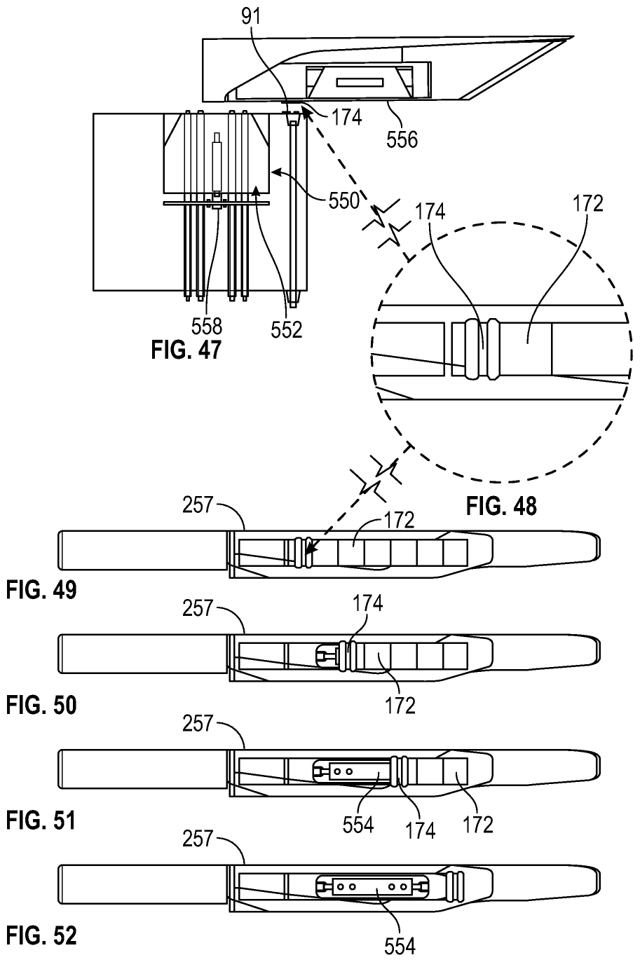

FIG. 33 shows an alternative anchor and connector combination 550. Anchor 550 includes a plurality of electrical lines 552 positioned therein. In an embodiment, electrical lines 552 can connect electrical power between docking structure 74 and vehicle 14. In the configuration of FIG. 33, instead of moving an electrical connector and an anchor separately, element 550 is a combined anchor and electrical connector, or anchor connector. Anchor connector 550 can be engaged and disengaged from an anchor receptacle 556 and then receptacle connector 554 positioned in vehicle 14 by, for example an actuator 558. Actuator 558 can be, for example, a ball screw linear actuator, a hydraulic piston, a pneumatic piston, a solenoid, a mechanical actuator that is manually operated, or other mechanism. Also see FIGS. 47-52, which show anchor connector 550 in a configuration similar to that of anchor 240 in FIGS. 41-46.

FIG. 34 shows a perspective view of vehicle 14 at the parked position with respect to docking platform 214 of docking structure 74.

FIG. 35 shows a cross-sectional view of vehicle 14 of FIG. 27 showing seats 66 and a supporting seat rail 218 configuration in accordance with an exemplary embodiment of the present disclosure. Each seat 66 can be supported by two seat rails 218. Each seat 66 can be driven or moved relative to vehicle 14 by a seat drive motor 220 by way of a seat drive 222 such as a ball screw linear actuator or other drive mechanism.

In the embodiment of FIG. 35, each seat 66 includes a bucket 254 to support the driver and/or the passenger in a vertical direction. To provide an interface and integration with platform 214 of occupancy space 12, seat 66 includes interior transition support 256 that extends horizontally from edge 258 of bucket 254 to exterior transition support 257 in transverse direction 99 that is transverse to longitudinally extending centerline 98 of vehicle 14. Accordingly, when driver 88, or the passenger, moves from bucket 254, which can also be described as a transverse center of seat 66, to platform 214, a person moves transversely across transition support 236 to docking platform 214. In a preferred embodiment, the person or user moves across edge 258, along upper surface 237 of interior transition support 256, across upper surface 237 of exterior transition support 257 since the driver or passenger moves along exterior transition support 257 from interior transition support 256, and then onto platform 214. Also see FIGS. 36-38. If seal 262 is positioned in transition support 236, the user may compress seal 262 as the user crosses upper surface 237 to move to docking structure platform 214.

While interior transition support 256 can extend horizontally from bucket edge 258, in the exemplary embodiment of FIG. 25 a portion of transition support, specifically transition support portion 266, can extend transversely from bucket edge 258 at a downward angle of approximately 25 degrees toward interior transition support portion 256 and exterior transition support portion 257 of transitions support 236. The angle can be any range that extends from about 0 degrees to about 50 degrees. In a preferred embodiment, the angle is in a range of about 10 degrees to about 45 degrees. In another preferred embodiment, the angle is in a range of about 10 degrees to about 40 degrees. In still another preferred embodiment, the angle is in a range of about 15 degrees to about 35 degrees. In a most preferred embodiment, the angle is in a range of about 20 degrees to about 30 degrees.

Also, in the exemplary embodiment of FIG. 35, exterior transition support 257 extends horizontally from an area that is approximately adjacent to an outer edge 260 of interior transition support 256 to an outer transverse extent of vehicle 14 at the location of transition support 236. As should be apparent from FIG. 35, the outermost side of exterior transition support 257 is on one side of clearance 204 between vehicle 14 and platform 214 when vehicle 14 is positioned in dock space 64.

While the description of transition support 236 has been principally for egress from vehicle 14, which can include interior transition support 256 and exterior transition support 257, transition support 236, including interior transition support 256 and exterior transition support 257, is configured to aid ingress to vehicle 14. More specifically, as driver 88 or the passenger enter vehicle 14, driver 88 (or the passenger) moves transversely to vehicle 14 from platform 214 along upper surface 237 of transition support 236, which can include movement along upper surface 237 of exterior transition support 257, then along upper surface 237 of interior transition support 256 and over bucket edge 258, finally obtaining a position in bucket 254.

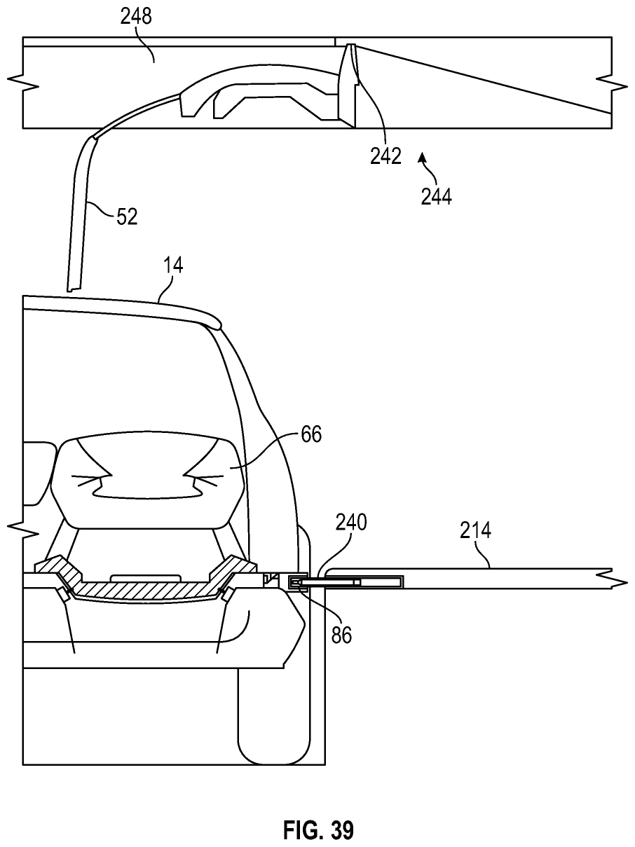

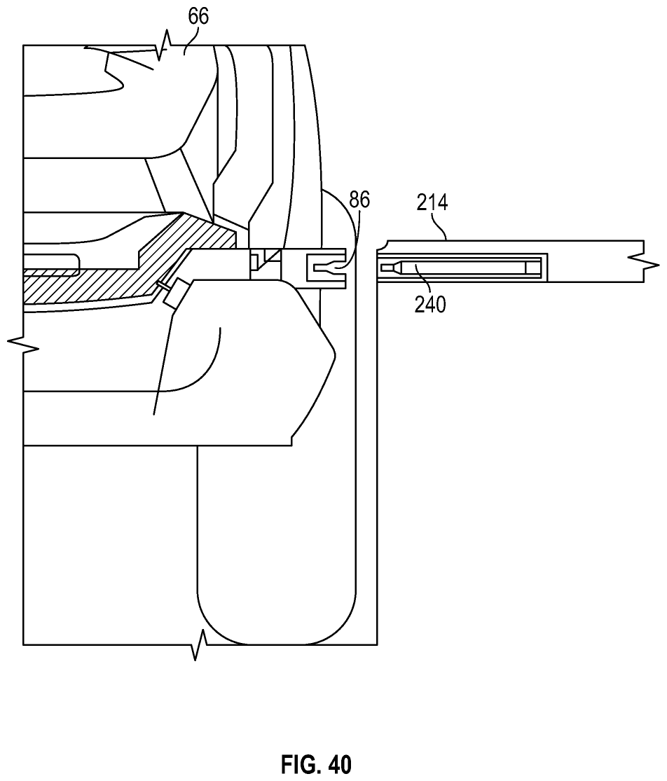

FIGS. 39 and 40 show cross sections through anchor 240 and vehicle receptacle 86 for anchor 240 with a driver's side vehicle door closed and open in accordance with an exemplary embodiment of the present disclosure. It should be apparent that is a side view of vehicle 14, anchor 240 overlaps or is an overlapping relationship with anchor receptacle 86 when anchor receptacle 86 and anchor 240 are viewed from a direction that is perpendicular to the longitudinal direction. In an exemplary embodiment, anchor 240 can be shaped as a wedge. In another exemplary embodiment, anchor 240 can be a cone shape. In still another exemplary embodiment, anchor 240 can be shaped as a spiral such as a coarse thread. In an exemplary embodiment, the shape of anchor 240, such as a wedge or cone, is configured to accommodate acceptable misalignment between anchor 240 and anchor receptacle 86. The ability to accommodate minor misalignment is preferable because the principal alignment is between transition support 236 and docking structure platform 214, as described hereinabove. That alignment may lead to a few millimeters of different between the vehicle anchor and the structure anchor, and the wedge or cone shape is configured to handle misalignments in a range from 10 millimeters to 20 millimeters depending on the design of the wedge. In a preferred embodiment, structure anchor 240 is configured to accommodate a misalignment up to a half inch or up to 12.5 mm with respect to vehicle anchor receptacle 86. Accordingly, when docking anchor 240 engages anchor receptacle 86, anchor 240 can force alignment of vehicle 14 with anchor 240 of occupancy space 12. It should be noted that after anchor 240 engages anchor receptacle 86, vehicle brakes, including vehicle parking brakes, can be actuated or engaged to provide additional resistance to movement of vehicle 14 when vehicle 14 is anchored in docking space 64. While in a preferred embodiment only one side of vehicle 14 is anchored to an adjacent docking structure, in another preferred embodiment an anchor can be positioned on each side of vehicle 14 to engage both sides of vehicle 14. By anchoring both side of vehicle 14 alignment of vehicle 14 with respect to respective docking structures 74 can be improved, and rigidity of anchoring to docking structures 74 can be enhanced.

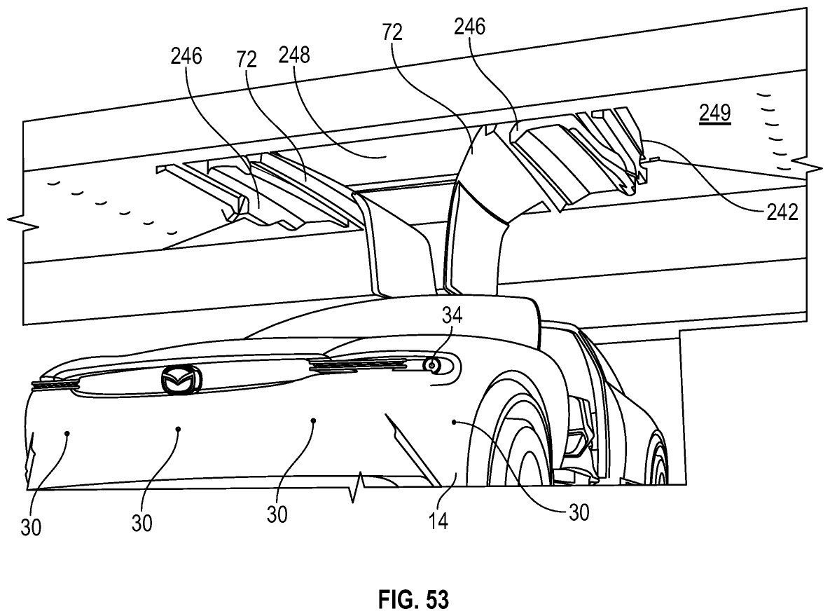

FIG. 53 shows a perspective view of vehicle 14 of FIG. 11 from a front left side of vehicle 14, with doors 72 in contact with a ceiling 244 of occupancy space 12. Ceiling 244 can include a recessed area 248 that provide a nesting area for sides of doors 72 when doors 72 are fully raised to be in contact with ceiling 244. It should be noted that in an exemplary embodiment, seat side bolster 246 moves with doors 72. One or both doors 72 can include an integral connector that mates with a ceiling connector 242 when doors 72 are raised to extend into recesses area 248.

It should further be noted that while anchoring may be described, for example, in terms of anchor 240 and anchor receptacle 86, vehicle doors 72 can engage structure 74 to accordingly anchor vehicle 14, or to provide additional anchoring of vehicle 14. For example, as shown in FIG. 53, vehicle doors 72 engage recessed area 248 of ceiling 244 of occupancy space 12.

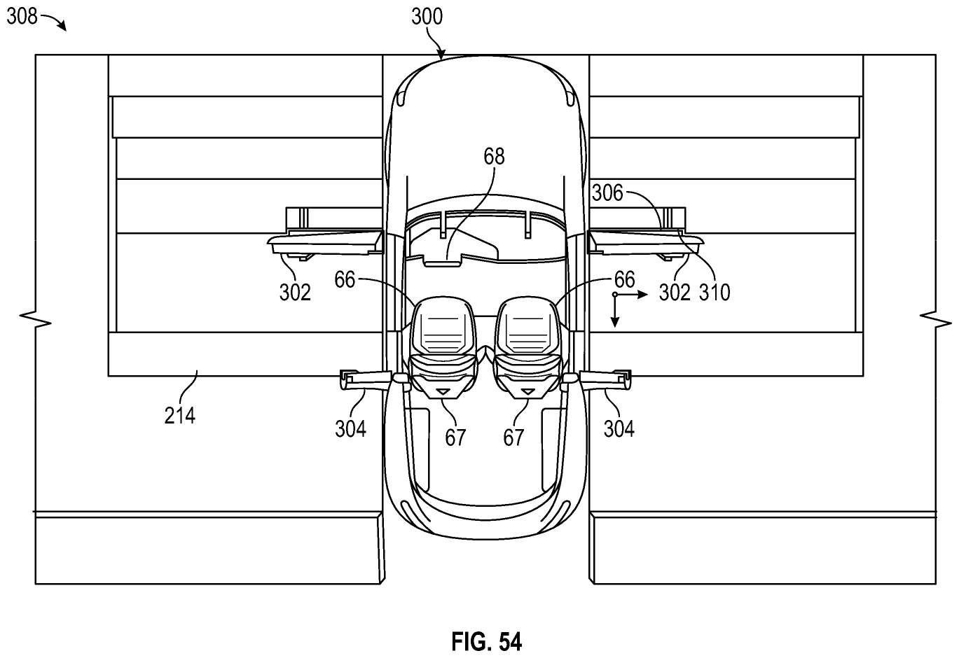

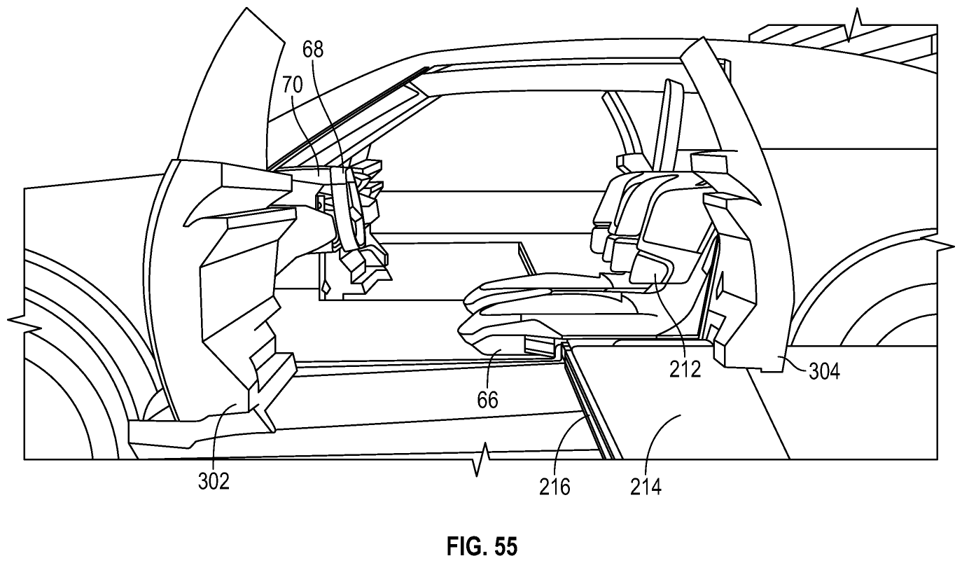

FIG. 54 shows a plan view of another vehicle 300 parked in an occupancy space 308 in accordance with an exemplary embodiment of the present disclosure. Vehicle 300 includes a front vehicle door 302 that pivots toward the front of vehicle 300 to open and a rear vehicle door 304 that pivots to the rear of vehicle 300 to open. In the exemplary embodiment of FIG. 54, connectors 306 can be located in door 302 or door 304 to mate with a structure connector 310. FIG. 55 shows a side view of vehicle 300 of FIG. 54 with vehicle 300 in the parked position and with the left side doors 302 and 304 open in accordance with an exemplary embodiment of the present disclosure.

While various embodiments of the disclosure have been shown and described, it should be understood that these embodiments are not limited thereto. The embodiments may be changed, modified, combined, and further applied by those skilled in the art. Therefore, these embodiments are not limited to the detail shown and described previously, but also include all such changes and modifications.

We claim:

1. A vehicle, comprising:
a longitudinally extending vehicle body forming a vehicle interior, a vehicle exterior, and a vehicle opening at a location between the vehicle interior and the vehicle exterior, the vehicle body including a vehicle door movable between an open position providing access between the vehicle interior and the vehicle exterior through the vehicle opening and a closed position limiting access between the vehicle interior and the vehicle exterior;
a vehicle seat positioned in the vehicle interior, the vehicle seat having a horizontally extending seating surface positioned at a seating height to provide vertical support to a user; and
a transition support positioned adjacent the vehicle seat and including a horizontally extending upper surface positioned at the vehicle opening at a support height at or greater than the seating height when the vehicle door is in both the closed position and the open position to vertically support a user during movement of a user between the vehicle interior and the vehicle exterior through the vehicle opening.

2. The vehicle of claim 1, including at least a front vehicle wheel and a rear vehicle wheel, and a vehicle anchor positioned at a location between the front vehicle wheel and the rear vehicle wheel to minimize movement of the vehicle.

3. The vehicle of claim 2, wherein the vehicle anchor is positioned at an anchor height that is less than the support height of the transition support.

4. The vehicle of claim 2, wherein the vehicle anchor is positioned in an overlapping relationship with the transition support along the longitudinal extent of the vehicle.

5. The vehicle of claim 1, wherein the vehicle seat is configured to move relative to the vehicle while maintaining a fixed position with respect to a fixed exterior location during movement of the vehicle.

6. The vehicle of claim 1, wherein the vehicle door engages the transition support to form a seal when the vehicle door is closed.

7. The vehicle of claim 6, wherein the seal is formed at the support height.

8. The vehicle of claim 1, wherein an end of the transition support is exposed to an exterior space alongside the vehicle when the vehicle door is closed.

9. The vehicle of claim 1, wherein a seal is positioned in a top surface of the transition support in contact with the lowermost edge of the vehicle door when the vehicle door is closed.

10. The vehicle of claim 1, wherein the transition support is in contact with the vehicle door when the vehicle door is in the closed position.

11. A method of integrating a vehicle with a docking structure, the method comprising:
providing the vehicle with a longitudinally extending vehicle body forming a vehicle interior, a vehicle exterior, and a vehicle opening at a location between the vehicle interior and the vehicle exterior, the vehicle including a vehicle seat positioned in the vehicle interior and a transition support including a horizontally extending upper surface positioned adjacent the vehicle seat to provide vertical support to a user;
moving the vehicle in a moving direction alongside the docking structure;
stopping movement of the transition support in the moving direction relative to a docking structure platform when the transition support is aligned in an aligned position with the docking structure platform along the moving direction of the vehicle; and
further moving the vehicle in the moving direction relative to the docking structure platform and the transition support after the transition support is aligned with the docking structure platform.

12. The method of claim 11, wherein the vehicle continuously moves while stopping movement of the transition support relative to the docking structure platform.

13. The method of claim 11, wherein the vehicle is at a first position when the transition support is aligned with the docking structure platform and the vehicle is stopped at a second position with respect to the docking structure after further moving the vehicle from the first position.

14. The method of claim 13, including stopping the movement of the transition support relative to the vehicle in the movement direction when the vehicle stops.

15. The method of claim 13, including retracting a steering wheel of the vehicle toward a dashboard of the vehicle while the vehicle moves from the first position to the second position.

16. The method of claim 15, wherein the steering wheel is retracted at a rate that is proportional to the distance between the first position and the second position such that the steering wheel is fully retracted at the second position.

17. The method of claim 13, including fixing a position of the vehicle seat in the moving direction of the vehicle with respect to the docking structure platform during movement of the vehicle from the first position to the second position.

18. The method of claim 13, including opening a door of the vehicle only after the vehicle stops at the second position.

19. The method of claim 13, including anchoring the vehicle after the vehicle stops at the second position.

20. The method of claim 19, including opening the vehicle door only after the vehicle is anchored.

21. The method of claim 11, wherein the transition support and the docking support platform are aligned in a vertical direction at the aligned position.

22. A vehicle and docking structure integration system, comprising:
a longitudinally extending vehicle body forming a vehicle interior, a vehicle exterior, and a vehicle opening at a location between the vehicle interior and the vehicle exterior, the vehicle body including a vehicle door movable between an open position providing access between the vehicle interior and the vehicle exterior through the vehicle opening and a closed position limiting access between the vehicle interior and the vehicle exterior;
a vehicle seat positioned in the vehicle interior, the vehicle seat having a horizontally extending seating surface positioned at a seating height to provide vertical support to a user;
a transition support positioned adjacent the vehicle seat and including a horizontally extending upper surface positioned at the vehicle opening at a support height greater than the seating height when the vehicle door is in both the closed position and the open position to vertically support a user during movement of a user between the vehicle interior and the vehicle exterior through the vehicle opening; and
a docking structure including a docking structure platform positioned at the support height in vertical and horizontal alignment with the transition support.

23. The system of claim 22, including at least a front vehicle wheel and a rear vehicle wheel, and a vehicle anchor positioned at a location between the front vehicle wheel and the rear vehicle wheel to minimize movement of the vehicle.

24. The system of claim 23, wherein the vehicle anchor is positioned at an anchor height that is less than the support height of the transition support.

25. The system of claim 23, wherein the vehicle anchor is positioned in an overlapping relationship with the transition support along the longitudinal extent of the vehicle.

26. The system of claim 22, wherein the vehicle seat is configured to move relative to the vehicle while maintaining a fixed position with respect to a fixed exterior location during movement of the vehicle.

27. The system of claim 22, wherein the vehicle door engages the transition support to form a seal when the vehicle door is closed.

28. The system of claim 27, wherein the seal is formed at the support height.

29. The system of claim 22, wherein an end of the transition support is exposed to an exterior alongside the vehicle when the vehicle door is closed.

30. The system of claim 22, wherein a seal is positioned in a top surface of the transition support in contact with the lowermost edge of the vehicle door when the vehicle door is closed.

31. The system of claim 22, wherein the transition support is in contact with the vehicle door when the vehicle door is in the closed position.
